(19) United States
(12) Patent Application Publication
(10) Pub. No.: US 2009/0008223 A1
(43) Pub. Date: Jan. 8, 2009

(54) Feed conveying apparatus

(75) Inventor: Kazumi Fujii, Gunma (JP)

Correspondence Address: JORDAN AND HAMBURG LLP, 122 EAST 42ND STREET, SUITE 4000, NEW YORK, NY, 10168, US

(73) Assignee: Kabushiki Kaisha Fuji Shoukai, Maebashi-shi (JP)

(21) Appl. No.: 10/568,902

(22) PCT Filed: Feb. 16, 2005
(86) PCT No.: PCT/JP2005/002307

§ 371 Date: Feb. 16, 2006

(51) Int. Cl. B65G 23/44

(52) U.S. Cl. 198/813

(57) ABSTRACT

There is provided a feed conveying apparatus in which the occurrence of a trouble due to a looseness of a disk cable is certainly prevented and feed is efficiently and stably conveyed into a feed conveying path by the disk cable without being left in the path.

A cable driving unit has a looseness eliminating member for guiding the feeding direction of the disk cable and eliminating the looseness at a feeding start position where the disk cable is fed out from a tooth portion of the outer circumference of the driving wheel toward the downstream side in the tangential direction. The feed conveying path formed by a pipe or the like is equipped with a cable pressing metal fitting for guiding the disk cable along a bottom surface portion in the feed conveying path while suppressing the floating of the disk cable running in the feed conveying path from an upper position.

### BACKGROUND OF THE INVENTION

The invention relates to a feed conveying apparatus constructed in such a manner that a disk cable to which a number of feed conveying disks are assembled at regular intervals by penetrating a cable through the centers of the disks is endlessly suspended and arranged in a feed conveying path formed by an endless pipe or the like and the disk cable is driven, thereby conveying feed for breeding cows, pig farming, chicken farming, or the like to a feed supplier side.

Hitherto, as shown in FIG. 26, such a kind of feed conveying apparatus generally uses a single-driving unit system in which a disk cable 3 is endlessly coupled and inserted in a pipe 2 that is provided with several corner portions 2a are provided in accordance with a setting layout of a number of feed suppliers 1 and is endlessly formed and one driving unit 4 of the disk cable 3 is provided at a position on the way of a feed conveying path of the pipe 2. According to the single-driving unit system, the disk cable 3 is wound around a corner feeding pulley in the corner portion 2a of the pipe 2. As shown in the diagram which partially enlargedly illustrates an internal structure, the disk cable 3 is suspended between a driving wheel 5 and a driven wheel 6 in the cable driving unit 4. Upon driving, by rotating the driving wheel 5 by a driving motor equipped for the cable driving unit 4, the disk cable 3 is circulated through the feed conveying path in the pipe 2.

In the cable driving unit 4, the driving wheel 5 is a gear wheel having teeth 5a on its rim outer circumference and is directly coupled with a driving shaft of the driving motor and axially supported. The disk cable 3 is wound around the driving wheel 5 in the state where a plurality of disks 3a are come into engagement with the teeth 5a. The driven wheel 6 is rotatably axially supported and the disk cable 3 is wound around the driven wheel 6 in the retaining state where the disks 3a are standing on the outer circumference of a rim 6a. According to the conventional feed conveying apparatus, while the driven wheel 6 is held by guide rail members 7 so as to be movable in the length direction of the pipe 2, the driven wheel 6 is urged with a spring in the direction opposite to a cable running direction (X) and a tension is always applied to the disk cable 3 by a tension applying mechanism 8. As mentioned above, the conventional feed conveying apparatus has a structure in which the disk cable 3 is endlessly suspended in the pipe 2 and, upon driving, the disk cable 3 is run along the feed conveying path in the pipe 2 while being stretched without a looseness.

However, in the feed conveying apparatus of the single-driving unit system, dust of the feed scattering in a box-type casing 4a of the cable driving unit 4 is aggregated onto pulleys 8a or the like of the tension applying mechanism 8 by the moisture. The tension applying mechanism 8 is made inoperative due to the aggregated dust. Thus, a looseness of the disk cable 3 occurs at a feeding start position (P) where the disk cable is fed out from the outer circumference of the driving wheel 5 toward the downstream side in its tangential direction. According to the conventional feed conveying apparatus, therefore, the loosed portion of the disk cable 3 clings to the teeth 5a of the driving wheel 5, the disk cable is wound around the outer peripheral tooth portion as shown in FIG. 27 in accordance with the rotation of the driving wheel 5, and the disks 3a bite in the tooth grooves. Thus, there is such a problem that a situation of cable snapping is caused in dependence on the circumstances, so that a serious situation such as feed conveyance inability occurs.

To prevent such a problem, therefore, among other conventional feed conveying apparatuses, as shown in FIG. 28, there is a feed conveying apparatus having a structure of a multi-driving unit system in which each cable driving unit 4 is attached to a straight pipe portion on the upstream side in the cable running direction (X) near each corner portion 2a of the pipe 2 and each cable driving unit 4 is made operative in front of the corner portion 2a, thereby running the disk cable (refer to Patent Document 1). The conventional feed conveying apparatus has the following structure. As shown in FIG. 29(A), when the teeth 5a of the driving wheel 5 are come into engagement with the disks 3a of the disk cable 3 from the upper position and the driving wheel 5 is rotated by a driving motor (m), the disk cable 3 is pressed and moved and, moreover, as shown in FIG. 28, the corner portion 2a is formed by an arc-shaped curved pipe and the disk cable 3 is directly guided by the curved pipe without using the gear wheel, thereby performing the corner feeding. That is, the apparatus has a structure in which since a mechanism portion to wind the disk cable 3 around the outer circumference of the gear wheel and feed it does not exist in the pipe 2, a room for allowing the disk cable 3 to be loosened in the pipe 2 is small.

### Patent Document 1: JP-A-8-143125

### BRIEF SUMMARY OF THE INVENTION

However, hitherto, since the foregoing feed conveying apparatus of the multi-driving unit system has the feeding mechanism in which, when the driving wheel 5 is rotated and the disk cable 3 is run, as shown in FIG. 29(B), the disk cable 3 is pressed while strongly pressing each disk 3a by the tooth 5a of the driving wheel 5, there is the following problem. The disk 3a of the disk cable 3 strongly collides with a bottom surface portion 2c of an inner wall surface of a straight pipe portion 2b by a pressing force of the driving wheel 5 or is run while rubbing and scraping the bottom surface portion 2c. Thus, if such a motion is repeated, there occurs a conveyance trouble in which cracks or holes are formed in the bottom surface portion 2c with the elapse of time and the feed leaks from those gaps. Since the conventional feed conveying apparatus of the multi-driving unit system has the structure in which in the corner portion 2a, the disk cable 3 is directly corner-fed by the curved pipe without using the gear wheel, there is the following serious problem. The disk cable 3 is fed while the disks 3a are strongly rubbing the inner wall surface of the curved pipe and the cable is subjected to an excessive load, so that its frictional resistance becomes an obstacle to the cable run and the disk cable 3 cannot be smoothly moved in the feed conveying path. Due to those factors, hitherto, the feed cannot be efficiently and stably conveyed without leaving the feed in the feed conveying path in dependence on the disk cable 3.

The invention is, therefore, made in consideration of the above conventional problems in the feed conveying apparatus and it is an object of the invention to certainly prevent the occurrence of the trouble which is caused by the looseness of the disk cable and to efficiently and stably convey the feed by the disk cable without leaving the feed in the feed conveying path.

To solve the above problems, according to the first aspect of the invention, for example, like an embodiment shown in following FIGS. 1 to 6, there is provided a feed conveying apparatus (A) constructed in such a manner that a disk cable (a) to which a number of feed conveying disks 20 are assembled at regular intervals by penetrating a cable through the centers of the disks is endlessly suspended and arranged in a feed conveying path formed endlessly by providing a plurality of corner portions 12 in accordance with a setting layout of feed suppliers (C), each disk 20 is come into engagement with a tooth (g) of a driving wheel 25 equipped for a cable driving unit 15 and the disk cable is wound around the driving wheel, and the driving wheel 25 is driven by a driving motor (m) supported by a driving shaft 17, thereby conveying the feed while running the disk cable (a) along the feed conveying path, wherein the cable driving unit 15 has a looseness eliminating member (R) for guiding a feeding direction (S) of the disk cable (a) and eliminating a looseness at a feeding start position (P) where the disk cable (a) is fed out from a tooth portion 25a of the outer circumference of the driving wheel 25 toward the downstream side in the tangential direction, and the looseness eliminating member (R) comprises: a guide plate portion 35 which blocks between the teeth (g) of the driving wheel 25 and the disks 20 of the disk cable (a) at the feeding start position (P); and a supporting arm portion 34 which is rotatably come into engagement with the driving shaft 17 and coaxially coupled therewith and attaches the guide plate portion 35 to the cable driving unit 15 so that a guide angle position of the guide plate portion 35 can be adjusted in accordance with a feeding direction (S) of the disk cable (a).

According to the second aspect of the invention, in the feed conveying apparatus (A) according to the first aspect of the invention, for example, like an embodiment shown in following FIGS. 17 to 22, the feed conveying path is formed by an endless pipe (p) constructed by connecting a plurality of conveying pipes 69, the disk cable (a) which is endlessly coupled is inserted in the pipe (p), and each conveying pipe 69 has a cable pressing metal fitting 70 for guiding the disk cable along a bottom surface portion in the pipe (p) while suppressing floating of the disk cable (a) running in the pipe (p) from an upper position in the conveying pipe 69.

According to the third aspect of the invention, in the feed conveying apparatus (A) according to the second aspect of the invention, for example, like an embodiment shown in following FIGS. 17 to 22, a notched hole 69a is formed in the conveying pipe 69 at an attaching position of the cable pressing metal fitting 70, the cable pressing metal fitting 70 comprises an arc-pipe-shaped attaching cover 74 which is detachably attached to the conveying pipe 69 so as to be wound around an outer circumference thereof and a pressing rod member 75 made of a round rod which is fixed onto an inner circumferential surface of the conveying pipe 69, and the pressing rod member 75 is bent and molded in a convex shape so as to be inserted through the notched hole 69a along a cable running direction (X) over the disk cable (a) in the conveying pipe 69 when the attaching cover 74 is attached to the conveying pipe 69.

According to the fourth aspect of the invention, in the feed conveying apparatus (A) according to the first aspect of the invention, for example, like an embodiment shown in following FIGS. 10 to 15, the feed conveying path is formed by a gutter-shaped feed tub (q) which has a groove shape whose upper side is opened and whose groove bottom portion is curved in accordance with the disk shape of the disk cable (a).

According to the fifth aspect of the invention, in the feed conveying apparatus (A) according to the fourth aspect of the invention, for example, like an embodiment shown in following FIG. 16, the feed conveying path formed by the feed tub (q) is constructed so that a feed inserting position (W) is set to a height position where the feed (b) can be manually directly inserted from an upper position into the feed conveying path.

According to the sixth aspect of the invention, in the feed conveying apparatus (A) according to the fourth or fifth aspects of the invention, for example, like an embodiment shown in following FIGS. 23 to 25, the feed conveying path is formed by the endless feed tub (q) constructed by connecting a plurality of tub-shaped rails 40, the disk cable (a) connected endlessly is arranged in the feed tub (q), and each tub-shaped rail 40 has a cable pressing metal fitting 80 which is put on the tub-shaped rail 40 and attached thereto and guides the disk cable (a) along a groove bottom surface in the feed tub (q) while suppressing the floating of the disk cable (a) running in the feed tub (q).

According to the seventh aspect of the invention, in the feed conveying apparatus (A) according to the sixth aspect of the invention, for example, like an embodiment shown in following FIGS. 23 to 25, the cable pressing metal fitting 80 comprises an attaching cover 81 which is come into engagement with open side upper edges of the tub-shaped rail 40 and detachably covered thereon and pressing rods 85 which are fixed onto the inner surface of the attaching cover 81, and the pressing rods 85 are bent and molded into a convex shape so as to be inserted along the cable running direction (X) over the disk cable (a) in the tub-shaped rail 40 when the attaching cover 81 is covered onto the tub-shaped rail 40.

According to the eighth aspect of the invention, in the feed conveying apparatus (A) according to any one of the first through seventh aspects of the invention, for example, like embodiments shown in following FIGS. 7 to 25, the cable driving units 15 are positioned in the corner portions 12 of the feed conveying path, in each cable driving unit 15 in each corner portion 12, the disks 20 of the disk cable (a) are come into engagement with teeth (g) of the driving wheel 25 or 45 and the disk cable is wound around the wheel, and the disk cable (a) is corner-driven by each driving motor (m).

According to the ninth aspect of the invention, in the feed conveying apparatus (A) according to any one of the first through eighth aspects of the invention, for example, like an embodiment shown in following FIGS. 10 to 15, the driving wheel 45 is constructed in such a manner that concave surface portions 55 on which each disk 20 is put in a standing state and convex portions 60 on which a cable portion 19 between the disks 20 is put and held when the disk cable (a) is wound around each driving wheel are alternately formed on the outer circumference of each rim 42, in the cable portion 19 between the disks 20, the disk cable (a) is supported at three points among the convex portion 60 and the two concave surface portions 55 and 55 and is wound in an arc shape which is concentric with the outer circumference of the rim 42.

According to the tenth aspect of the invention, in the feed conveying apparatus (A) according to the ninth aspect of the invention, for example, like an embodiment shown in following FIGS. 10 to 15, the driving wheel 45 is constructed in such a manner that the rim 42 and a pair of ring-shaped elastic pads 43 which are coaxially arranged so as to sandwich the rim 42 are detachably fitted to an outer circumference of a boss 41, respectively, a taper surface 43b having an arc-shaped cross section is formed on an outer circumference of each of the elastic pads 43, when the taper surfaces 43b are fitted into the boss 41 so as to face each other, a disk guide groove 65 having a circular cross section with which the disks 20 of the disk cable (a) wound around the driving wheel 45 can be come into engagement is formed on the outer circumference of the driving wheel 45, the rim 42 is constructed by a plurality of ring-shaped spacer plates 49 of the same shape in each of which a concave portion 55a and a convex portion 60a are alternately formed on the outer circumference so that the concave surface portions 55 and the convex portions 60 are formed when the spacer plates 49 are piled, and an interval between the elastic pads 43 with which the disks 20 are come into engagement can be adjusted by increasing or decreasing the number of spacer plates 49 which are fitted into the boss 41 in accordance with a radius size of the disk 20 of the disk cable (a) which is used.

According to the first aspect of the invention, (1) when the driving wheel is rotated and the disk cable is fed out of the tooth portion of the outer circumference, the feeding direction of the disk cable is always guided by the guide plate portion of the looseness eliminating member for such a period of time and the looseness of the disk cable can be eliminated at the feeding start position. Since no looseness is caused in the disk cable at the feeding start position as mentioned above, such a conventional problem that the serious trouble occurs, that is, the loose portion of the disk cable clings to the teeth of the driving wheel, the disk cable is wound around the wheel, the situation of the cable snapping is caused, the feed conveyance inability occurs, and the like can be certainly eliminated. (2) In the shaft engagement concave portion of the supporting arm portion, by rotating the looseness eliminating member around the driving shaft as a fulcrum, a guide angle position of the guide plate portion can be adjusted in accordance with an angle position of the feeding direction of the disk cable. Therefore, for example, even in the case where the angle of the feeding direction of the disk cable to the driving wheel differs, the case where the feeding start positions of the disk cables differ to be the upper and lower positions, or the like, by rotating the looseness eliminating member, adjusting the guide angle position of the guide plate portion, and fixing it at the adjusted position, the invention can be easily adapted to differences among the standards of companies.

According to the second aspect of the invention, when the disk cable is run in the pipe and the feed is conveyed, even if the disk cable is pressed by a flow of the feed and is floated upward in the pipe, the floating of the disk cable is suppressed by the cable pressing metal fitting from an upper position in the conveying pipe and the disk cable is guided so as to run along the bottom surface portion in the pipe. Therefore, all of the feed is conveyed by the disk cable without being left in the pipe and on the bottom side of the pipe. Thus, the occurrence of the feed accumulation is perfectly eliminated and the trouble such as cable snapping or the like is also eliminated. Moreover, a problem of the feed separation in the pipe (problem in which a feed group is separated into, for example, coarse particles on the surface layer side and fine components such as an additive or the like remaining on the bottom side in the feed conveying path) does not occur at all. Consequently, conveying efficiency is remarkably improved and the hygienic problems can be also perfectly eliminated.

According to the third aspect of the invention, (1) the pressing rod member of the cable pressing metal fitting is made of the round rod and is bent and molded in the convex shape in the state where it is inserted onto the disk cable along the cable running direction in which the feed is conveyed.

Therefore, when the feed is conveyed, the situation where the pressing rod member becomes a resistor and obstructs the conveyance of the feed does not occur, and the operation to suppress the floating of the disk cable can be effectively executed. Further, (2) since the cable pressing metal fitting is constructed in such a manner that the attaching cover of the pressing rod member is detachably attached to the conveying pipe so as to be wound around the outer circumference thereof, in the endless pipe, the pressing rod member can be easily and simply exchanged and attached to a position where it is necessary to suppress the floating of the disk cable.

According to the fourth aspect of the invention, (1) since the feed conveying path is formed by the feed tub of the groove shape whose upper side is opened, when the feed is conveyed, even if an amount of feed which is conveyed by the disk cable is large, the remaining feed can be saved into the upper gap space. Therefore, an area where the feed is strongly come into contact with the inner wall surface of the tub is small. Consequently, the frictional resistance is small according to such a small area, the feed can be smoothly conveyed through the feed conveying path, and the feed conveyance amount can be increased. In addition, (2) since the feed conveying path is formed by the feed tub whose groove bottom portion is curved in accordance with the disk shape of the disk cable, the radius size of the disk is not limited but the disk cables having the disks of various large and small sizes can be widely used.

According to the fifth aspect of the invention, since the feed tub has the groove shape in which the feed conveying path is upwardly opened, a feed supplying apparatus having a feed tank or the like does not need to be separately arranged at the feed inserting position. The feed can be easily supplied by directly inserting the feed into the feed tub by proper means. Moreover, as feed, besides the coarse feed of large particles and grain feed of small particles, powder feed may be used. The invention is not limited to their dry feed but can also use a paste bait (liquid feed) or the like. The kind of feed is not limited but any kind of feed can be directly inserted into the feed tub and conveyed. Even the feed obtained by refining raw garbage such as dregs of bean curd (TOFU) or the like can be inserted and conveyed.

According to the sixth aspect of the invention, when the disk cable is run in the feed tub and the feed is conveyed, even if the disk cable is pressed by the flow of the feed and is floated upward in the feed tub, the floating of the disk cable is suppressed by the cable pressing metal fitting from an upper position of the tub-shaped rail and guided so that the disk cable runs along the groove bottom surface in the feed tub. Therefore, all of the feed is conveyed by the disk cable without being left in the feed tub and on the bottom side of the tub. Thus, the occurrence of the feed accumulation is perfectly eliminated and the occurrence of a trouble such as cable snapping or the like is also eliminated. Moreover, the problem of the feed separation in the feed tub does not occur at all. Consequently, conveying efficiency is remarkably improved and the hygienic problems can be also perfectly eliminated.

According to the seventh aspect of the invention, (1) the pressing rod member of the cable pressing metal fitting is made of the round rod and is bent and molded in the convex shape in the state where it is inserted onto the disk cable along the cable running direction in which the feed is conveyed. Therefore, when the feed is conveyed, the situation where the pressing rod member becomes the resistor and obstructs the conveyance of the feed does not occur, and the operation to suppress the floating of the disk cable can be effectively performed. Further, (2) since the cable pressing metal fitting is constructed in such a manner that the attaching cover of the pressing rod member is detachably covered onto the tub-shaped rails, in the endless feed tub, the pressing rod member can be easily and simply exchanged and attached to the position where it is necessary to suppress the floating of the disk cable.

According to the eighth aspect of the invention, the invention uses a driving load sharing system in which upon operating, in the respective corner portions, the driving motors of the cable driving unit are individually made operative, each driving wheel is rotated, and the same disk cable is run through the feed conveying path by the driving motors in the corner portions in a sharing manner. Therefore, the disk cable runs in the feed conveying path with little load resistance. Thus, the conveying speed and conveyance amount of the feed which is conveyed by the disk cable can be further increased as compared with those in the single-driving unit system without using the large driving motors and irrespective of the length of feed conveying path.

According to the ninth aspect of the invention, the invention uses the construction in which while the disk cable is circulated in the feed conveying path while being strongly stretched without a looseness, in the driving wheel in the cable driving unit, the disk is put in the standing state onto each concave surface portion, the cable portion between the disk is put in the state where it is hung on the convex portion, and in the cable portion, the disk cable is run while always being supported by the three points of the convex portion and the two concave surface portions. Therefore, the disk cable is conveyed while drawing an arc which is concentric with the rim outer circumference without being locally bent around the wheel. Thus, the disk cable is smoothly circulated without being applied to anywhere of the cable portion with a bending load which becomes a cause of a metal fatigue and the occurrence of the cable snapping which has become the problem hitherto can be certainly prevented. Consequently, the feed conveying apparatus in which the occurrence of a failure caused by the cable snapping is perfectly eliminated, the whole running cost and maintenance cost are minimized, and it is also advantageous in terms of the costs can be provided.

According to the ninth aspect of the invention, as for the rim, the interval between the elastic pads with which the disks are come into engagement is adjusted by increasing or decreasing the number of spacer plates to be fitted into the boss in accordance with the radius size of the disk of the disk cable. Therefore, for the disk cable which is used, the common driving wheels can be always used so as to be adjusted to the disks of various radius sizes without needing the different driving wheels every radius size of the disk. In the driving wheel, even if the disk guide groove of the elastic pad is abraded with the elapse of time, by removing the elastic pad from the boss, pulling out the spacer plates of the necessary number in accordance with a degree of the abrasion of the disk guide groove, and adjusting the interval between the elastic pads of the disk guide groove, the disk guide groove can be always easily adjusted to the disks. Consequently, upon driving of the disk cable, when the disk passes through the disk guide groove of the driving wheel, it is always fitted into the disk guide groove and smoothly come into engagement therewith out slipping, thereby enabling the rotating force to be accurately transferred.

### BRIEF DESCRIPTION OF THE DRAWINGS

Accompanying the specification are figures which assist in illustrating the embodiments of the invention, in which:

FIG. 1 is a perspective view showing a cable looseness eliminating structure of a cable driving unit equipped for a feed conveying apparatus according to the first embodiment of the invention.

FIG. 2 is an exploded perspective view of the cable driving unit of the first embodiment.

FIG. 3 is a partial plan view showing the cable driving unit of the first embodiment.

FIG. 4 is a front view showing an internal structure of the cable driving unit of the first embodiment.

FIGS. 5(A)-(C) illustrate an explanatory diagram for explaining adjustment of a setting angle position of a looseness eliminating member.

FIG. 6 is a perspective view showing a whole construction of a feed supplying system having the feed conveying apparatus of the first embodiment of the invention.

FIG. 7 is a perspective view showing a whole construction of a feed supplying system having a feed conveying apparatus of the second embodiment of the invention.

FIG. 8 is a perspective view showing a cable looseness eliminating structure of a cable driving unit equipped for the feed conveying apparatus of the second embodiment.

FIG. 9 is a perspective view showing an attaching structure of a looseness eliminating member in the cable driving unit of the second embodiment.

FIG. 10 is a perspective view showing a whole construction of a feed supplying system having a feed conveying apparatus of the third embodiment of the invention.

FIGS. 11(A) and (B) illustrate a vertical sectional view showing a feed conveying state by a feed tub of the third embodiment in comparison with the case where a pipe is used.

FIG. 12 is a perspective view showing a cable looseness eliminating structure of a cable driving unit equipped for the feed conveying apparatus of the third embodiment.

FIG. 13 is an exploded perspective view of a pad type driving wheel equipped for the cable driving unit of the third embodiment.

FIG. 14(A) is a vertical sectional view showing an assembling state of the driving wheel of the third embodiment. FIG. 14(B) is a vertical sectional view showing the driving wheel assembled by adjusting an interval in accordance with a conveying disk having a large diameter.

FIG. 15(A) is a partial front view showing a supporting state of a disk cable by the driving wheel of the third embodiment. FIG. 15(B) is a perspective view showing the driving wheel in the winding state of the disk cable. FIG. 15(C) is a partial perspective view showing wire type disk cables having conveying disks of a small radius size and a large radius size and a chain type disk cable, respectively.

FIG. 16 is a perspective view showing a whole construction of a feed supplying system having a feed conveying apparatus of the fourth embodiment of the invention.

FIG. 17 is a perspective view showing a whole construction of a feed supplying system having a feed conveying apparatus of the fifth embodiment of the invention.

FIG. 18 is a partial perspective view showing a cable floating suppressing structure in a pipe of the fifth embodiment.

FIGS. 19(A) and (B) illustrate a perspective view showing a conveying pipe and a cable pressing metal fitting of the fifth embodiment.

FIGS. 20(A) and (B) illustrate an explanatory cross sectional view showing the state where the cable pressing metal fitting is attached to the conveying pipe of the fifth embodiment.

FIGS. 21(A) and (B) illustrate a vertical sectional view showing a cable floating suppressing state in the pipe by the cable pressing metal fitting of the fifth embodiment.

FIGS. 22(A) and (B) illustrate a reference cross sectional view for explaining the cable floating state in the general pipe.

FIG. 23 is a perspective view showing a whole construction of a feed supplying system having a feed conveying apparatus of the sixth embodiment of the invention.

FIG. 24 is exploded perspective view of a cable pressing metal fitting and a tub-shaped rail of the sixth embodiment of the invention.

FIGS. 25(A) and (B) illustrate a vertical sectional view showing a cable floating suppressing state in a feed tub by the cable pressing metal fitting of the sixth embodiment.

FIG. 26 is a perspective view showing a whole construction of a feed supplying system having a feed conveying apparatus of the conventional single-driving unit system, in which a cable driving unit is partially enlargedly illustrated.

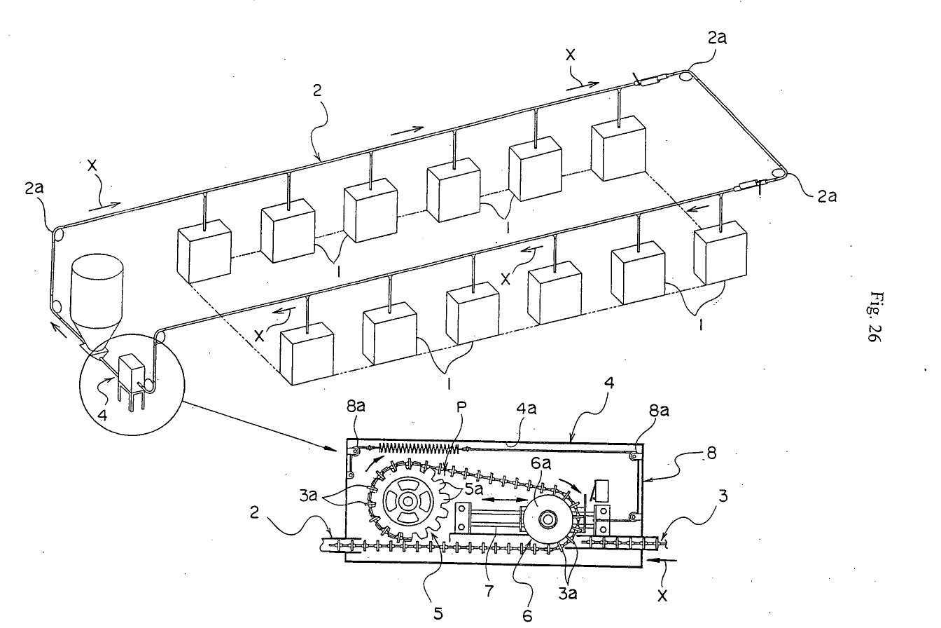

FIG. 27 is a perspective view showing a cable winding trouble state in a driving wheel equipped for the conventional feed conveying apparatus.

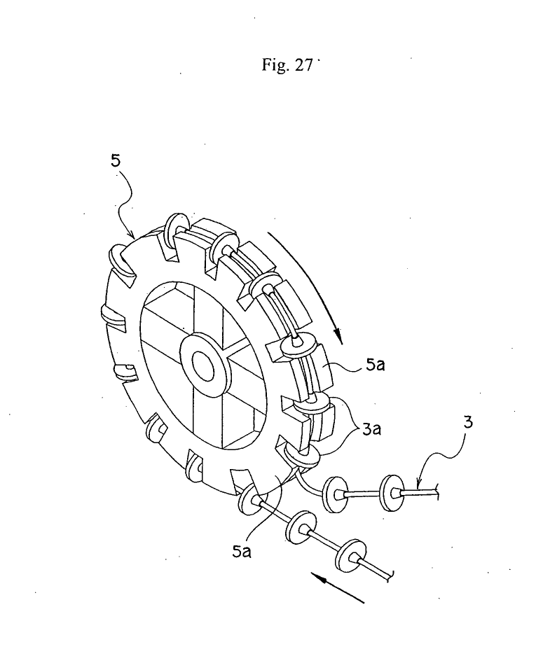

FIG. 28 is a perspective view showing a whole construction of a feed supplying system having a feed conveying apparatus of the conventional multi-driving unit system.

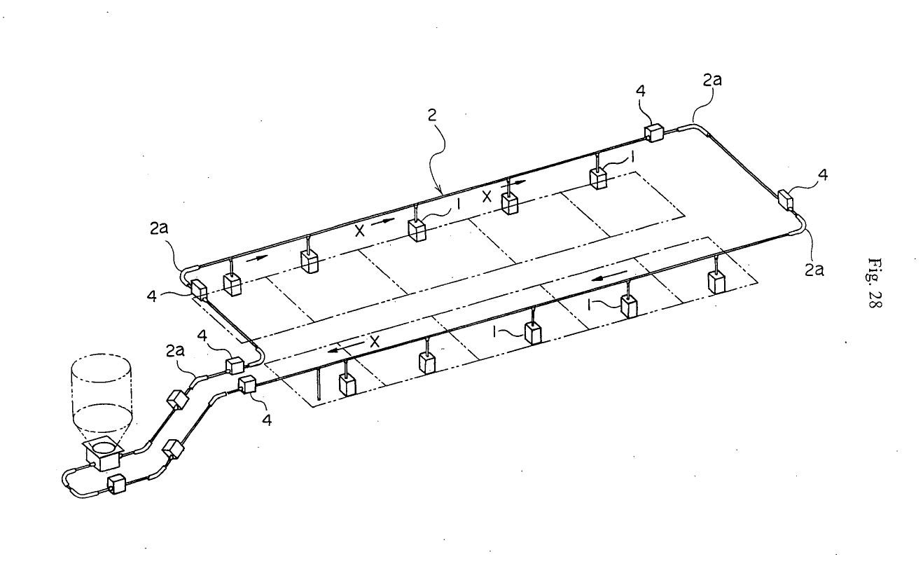

FIG. 29A is a perspective view showing a cable driving structure by a driving wheel equipped for the multi-driving unit system. FIG. 29B is a front view with a part enlargedly shown.

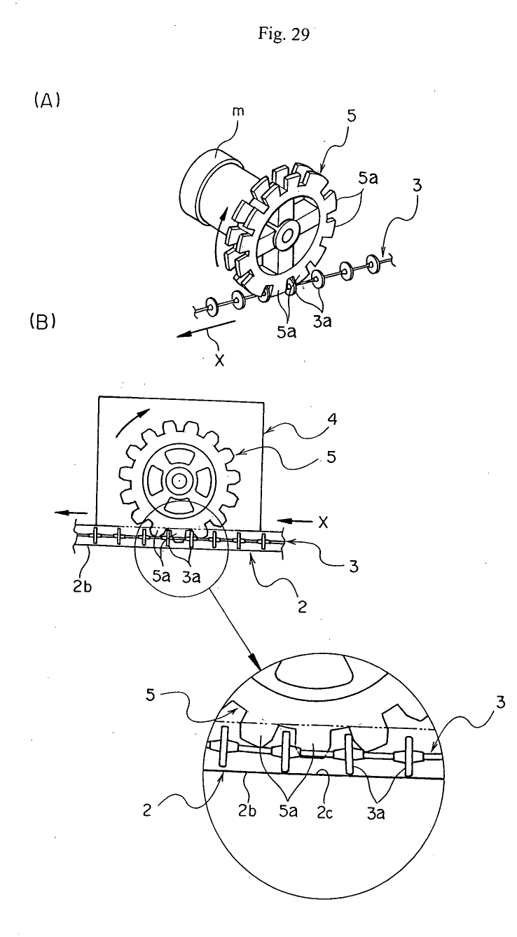

### DETAILED DESCRIPTION OF THE INVENTION

Best modes for carrying out the invention will be described in detail hereinbelow with reference to the drawings.

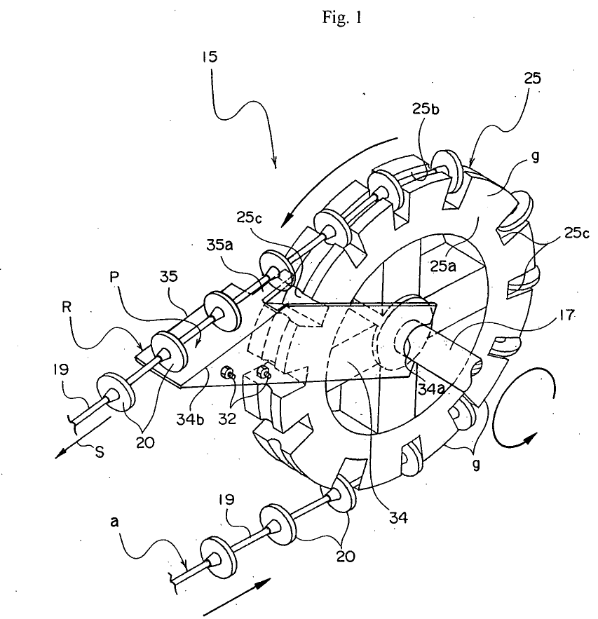

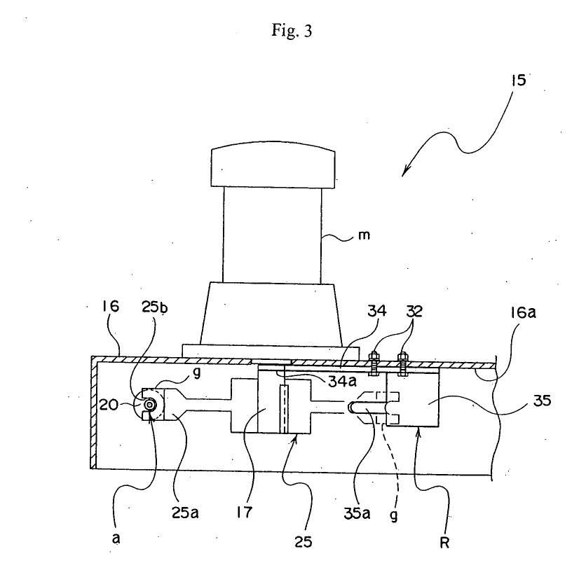

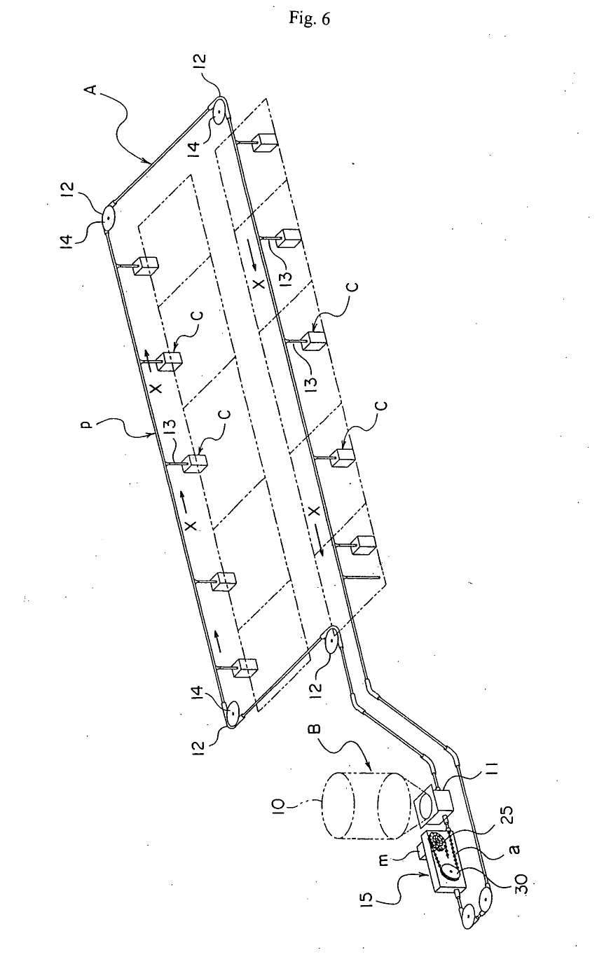

FIGS. 1 to 6 show the first embodiment of the best modes for carrying out a feed conveying apparatus according to the invention. FIG. 6 shows a whole construction of a feed supplying system having the first embodiment of the feed conveying apparatus according to the invention. The feed supplying system is realized, for example, as a feed supplying system for pig farming in a pig house and is constructed by: a feed conveying apparatus (A); a feed supplying apparatus B for supplying the feed from a feed tank 10 to the feed conveying apparatus (A) through a feed hopper 11; and a plurality of feed suppliers (C) on the destination sides to which the supplied feed is conveyed by the feed conveying apparatus (A).

The feed conveying apparatus A of the first embodiment has a pipe (p) constructed in a pipeline shape by providing a plurality of corner portions 12 in accordance with a setting layout of the feed suppliers (C) and couples the feed supplying apparatus (B) and each feed supplier (C) through the pipe (p). Each feed supplier (C) is communicated with the pipe (p) through a drop pipe 13 which is vertically and downwardly attached.

The pipe (p) forms a straight pipe portion by coupling a plurality of straight-pipe-shaped conveying pipes. The straight pipe portion is connected to the several corner portions 12. An endless feed conveying path is formed in the pipe (p). A disk cable (a) for feed conveyance is endlessly coupled and inserted in the hollow pipe. A cable driving unit 15 for driving the disk cable (a) is equipped for the pipe (p) on the way of the feed conveying path adjacent to the feed supplying apparatus (B). The corner portion 12 has a structure in which a corner feeding pulley (not shown) is rotatably and axially supported in a shallow corner cover 14 having a circular casing shape, the disk cable (a) is wound around the corner feeding pulley, and upon driving, the pulley is interlockingly rotated in association with the movement of the disk cable (a), thereby corner-feeding the disk cable (a).

The disk cable (a) (refer to FIGS. 1 to 4) is constructed in such a manner that a number of disks 20 each having a predetermined radius size are formed by, for example, an insertion resin molding method, a cable portion 19 as a wire made of a steel is penetrated through the center of each disk 20, the disks are assembled to the cable portions 19 at regular intervals and molded, joined by joint metal fittings, and endlessly coupled. As a disk cable (a), naturally, for example, a cable formed by a commercially available chain in place of the cable portions 19 may be used.

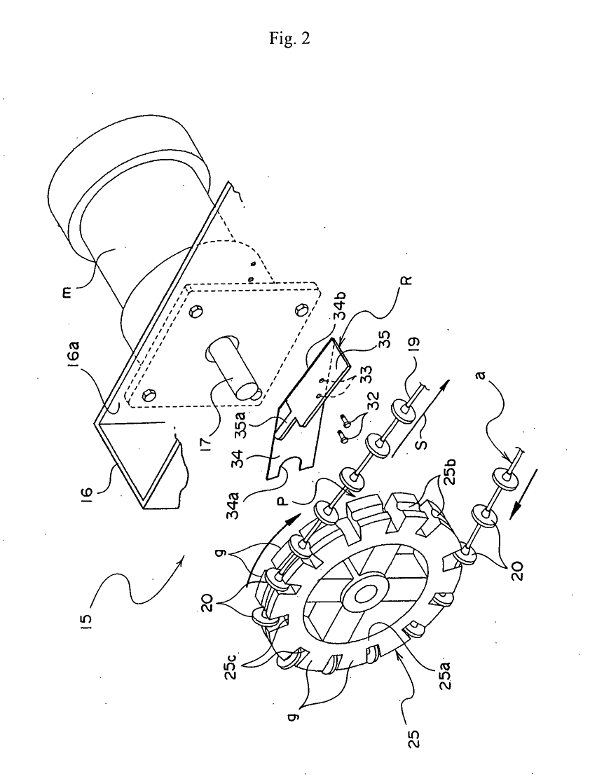

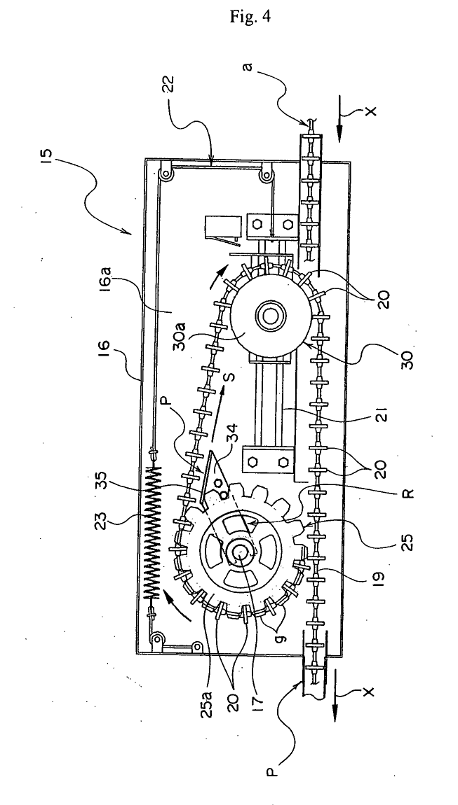

As for the cable driving unit 15 (refer to FIGS. 2 to 4), parts of a rotating system are assembled in a rectangular driving box 16 and the driving motor (m) is externally attached to a rear plate portion 16a of the driving box 16. In the driving box 16, a driving wheel 25 is directly coupled with a driving shaft 17 of the driving motor (m) and axially supported, a driven wheel 30 is axially supported so as to be interlockingly rotatable, and the disk cable (a) is suspended between the driving wheel 25 and the driven wheel 30. The driving wheel 25 is a gear wheel in which a cable guide groove 25b is formed in the tooth thickness direction on the tip surface of each tooth (g) provided for a tooth portion 25a of an outer circumference. The disks 20 are come into engagement with tooth grooves 25c and the cable portions 19 are come into engagement with the cable guide grooves 25b, and the disk cable (a) is wound around the outer circumference of the tooth portion 25a. As shown in FIG. 4, the driven wheel 30 is a disk-shaped pulley and has the following structure. The disk cable (a) is wound around the outer circumference of a rim 30a in the retaining state where the disks 20 are standing thereon. The driven wheel 30 is guided by a guide rail member 21 and held so as to be movable in the length direction (right/left direction in the diagram) of the pipe (p). The driven wheel 30 is urged in the direction opposite to the running direction (X) of the disk cable (a) by a spring 23 equipped for a tension applying mechanism 22, thereby always applying a tension to the disk cable (a). In this manner, the disk cable (a) is endlessly suspended and arranged in the pipe (p) and run and circulated while being stretched.

In the feed supplying system (refer to FIG. 6), therefore, upon feeding, the feed conveying apparatus (A) is made operative and the feed enclosed in the feed tank 10 is fed into the pipe (p) while adjusting a supply amount by the feed hopper 11. The cable driving unit 15 is made operative and the driving wheel 25 is rotated, thereby running the disk cable (a) along the feed conveying path in the pipe (p). Thus, the feed passes on the feed conveying path and is conveyed in the cable running direction (X) by the disks 20 of the disk cable (a). When the feed reaches a position above each feed supplier (C), the feed sequentially drops through the drop pipe 13 and is supplied into the feed supplier (C).

In the feed conveying apparatus (A) of the first embodiment, as shown in FIG. 4, the cable driving unit 15 is characterized in that a looseness eliminating member (R) for guiding a feeding direction (S) shown by an arrow in the diagram of the disk cable (a) and eliminating a looseness of the disk cable (a) is arranged at the feeding start position (P) where the disk cable (a) is wound from the lower side in the diagram of the tooth position 25a of the outer circumference of the driving wheel 25 and, thereafter, further, fed out to the downstream side in the tangential direction on the upper side in the diagram.

The looseness eliminating member (R) in the first embodiment is formed by using a metal plate and comprises: a supporting arm portion 34; and a guide plate portion 35 which is fixed to a front edge of the supporting arm portion 34. The supporting arm portion 34 (refer to FIGS. 1 to 3) is formed so as to have a length almost corresponding to a radius size of the driving wheel 25, a shaft engagement concave portion 34a which is notched in a semicircular shape in accordance with the driving shaft 17 is formed at a base edge, a taper which gradually becomes thin to a point is formed at a front edge, and the guide plate portion 35 is fixed to a taper portion 34b. In the supporting arm portion 34, bolt holes 33 and 33 are formed on the front edge side. In the guide plate portion 35, an elongated spear plate portion 35a is formed on one end side. The guide plate portion 35 is fixed to the taper portion 34b of the supporting arm portion 34 while the elongated spear plate portion 35a is directed toward the shaft engagement concave portion 34a.

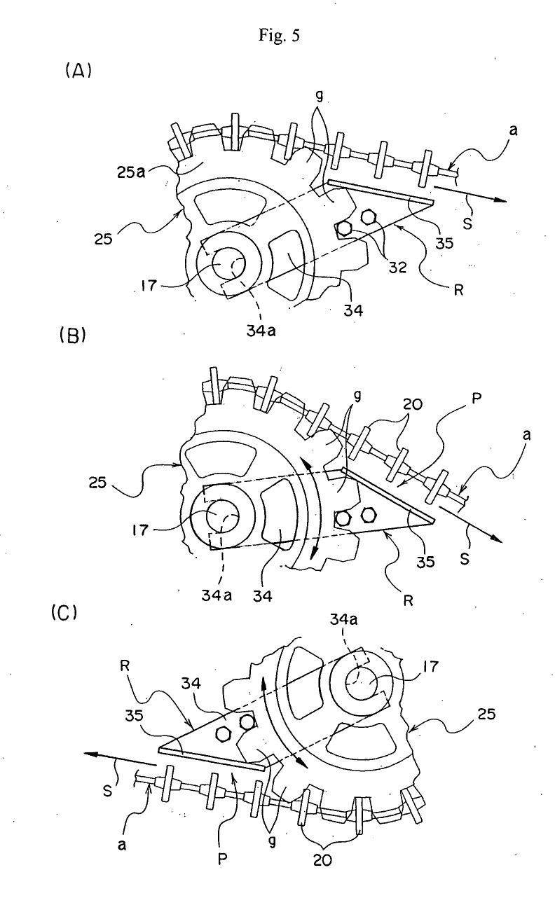

According to the looseness eliminating member (R) with such a shape, between the rear plate portion 16a of the driving box 16 and the driving wheel 25, the shaft engagement concave portion 34a is come into engagement with the driving shaft 17 and the supporting arm portion 34 is rotatably coupled therewith. At the feeding start position (P) of the disk cable (a), a tip of the spear plate portion 35a is allowed to approach the tooth grooves 25c of the driving wheel 25 and the guide plate portion 35 is arranged between the tooth (g) of the driving wheel 25 and the disk 20 of the disk cable (a). As shown in FIG. 5(A) as well, the guide plate portion 35 is positioned to an angle position adapted to block both of them and, thereafter, the supporting arm portion 34 is fixed to the rear plate portion 16a of the driving box 16 by bolts 32.

Therefore, in the feed conveying apparatus (A) of the first embodiment, upon operating, when the disk cable (a) is fed out of the tooth portion 25a of the outer circumference by rotating the driving wheel 25, the feeding direction (S) of the disk cable (a) is guided by the guide plate portion 35 of the looseness eliminating member (R) during such a period of time and the looseness of the disk cable (a) is eliminated at the feeding start position (P). Since no looseness is caused in the disk cable (a) at the feeding start position (P) as mentioned above, the conventional problem that the serious trouble occurs, that is, the loose portion of the disk cable (a) clings to the teeth (g) of the driving wheel 25, the disk cable is wound around the wheel, the situation of the cable snapping is caused, the feed conveyance inability occurs, and the like can be certainly eliminated.

In the shaft engagement concave portion 34a of the supporting arm portion 34, by rotating the looseness eliminating member (R) around the driving shaft 17 as a fulcrum, the guide angle position of the guide plate portion 35 can be adjusted in accordance with the angle position of the feeding direction (S) of the disk cable (a). Therefore, according to the invention, even when the angle of the cable feeding direction (S) to the driving wheel 25 differs, as shown in FIG. 5(B), by rotating the looseness eliminating member (R) in accordance with the angle difference, adjusting the guide angle position of the guide plate portion 35, and fixing the looseness eliminating member (R) to the driving box 16 at the adjusting position, the looseness eliminating member (R) can be easily adapted to the difference of the angle position of the cable feeding direction (S). On the contrary, even if the feeding start position (P) of the disk cable (a) is located at a lower position of the driving wheel 25 as shown in FIG. 5(C), by similarly and largely rotating the looseness eliminating member (R) and adjusting the guide angle position of the guide plate portion 35, it is possible to similarly easily cope with the difference of the feeding start position (P) itself of the disk cable (a).

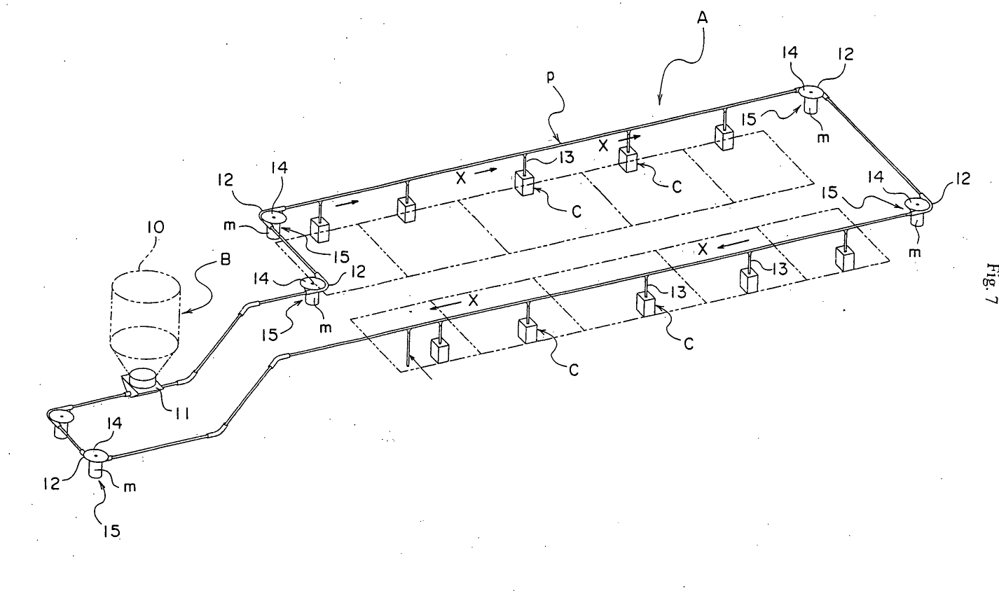

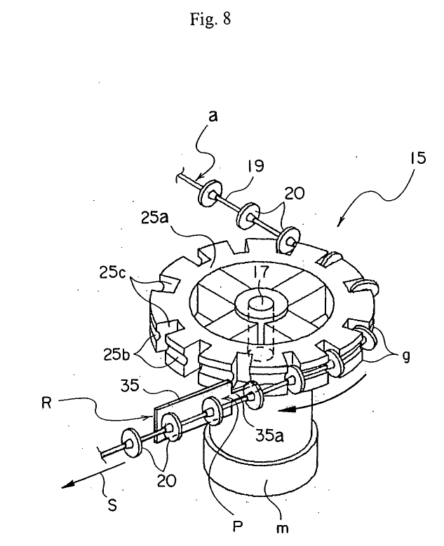

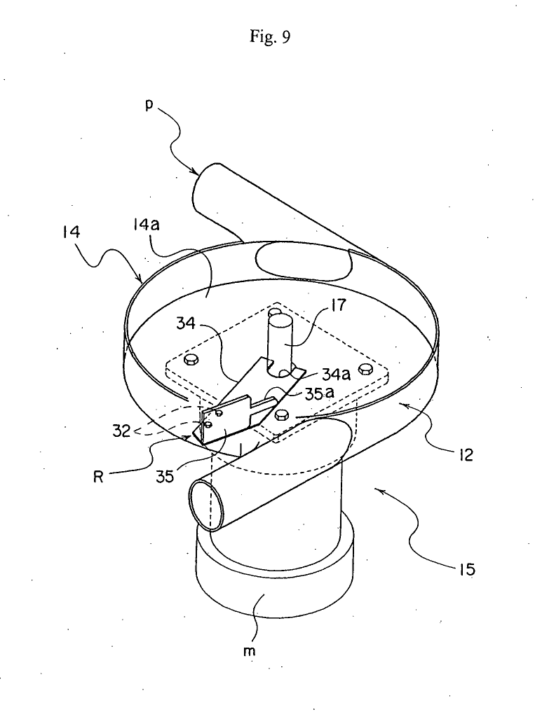

Subsequently, FIGS. 7 to 9 show the second embodiment of the best modes for carrying out the feed conveying apparatus according to the invention. The second embodiment shows a modification of the cable driving unit 15 of the first embodiment. FIG. 7 shows a whole construction of a feed supplying system having the second embodiment of the feed conveying apparatus according to the invention. FIGS. 8 and 9 show a structure of the corner portion 12 of the feed conveying apparatus (A) of the second embodiment. Therefore, in the second embodiment, the same constructing portions as those in the first embodiment are designated by the same reference numerals and will be explained hereinbelow.

The feed conveying apparatus (A) of the second embodiment is characterized by the corner driving system in which the cable driving units 15 are provided in the corner portions 12 of the pipe (p), in each cable driving unit, the disks 20 of the disk cable (a) are come into engagement with the teeth (g) of the driving wheel 25 and the disk cable is wound around the wheel, and the same disk cable (a) is driven by a plurality of driving motors (m) in a sharing manner.

According to the cable driving unit 15 of the second embodiment, as shown in FIGS. 8 and 9, the driving motor (m) is externally attached to a bottom surface plate portion 14a of each circular corner cover 14. In the corner cover 14, the driving wheel 25 is directly coupled with the driving shaft 17 of the driving motor (m) and axially supported, the disks 20 of the disk cable (a) are come into engagement with the teeth (g) of the driving wheel 25, the disk cable is wound around the wheel, and the disk cable (a) is rotated by the driving motors (m) of the corner portions 12 in a sharing manner.

Further, in the feed conveying apparatus (A) of the second embodiment, each cable driving unit 15 is characterized by a construction in which the looseness eliminating member (R) for guiding the feeding direction (S) of the disk cable (a) and eliminating its looseness is arranged at the feeding start position (P) of the driving wheel 25 where the disk cable (a) is fed out, respectively.

According to the looseness eliminating member (R), between the bottom surface plate portion 14a of the corner cover 14 and the driving wheel 25, the shaft engagement concave portion 34a is come into engagement with the driving shaft 17 and the supporting arm portion 34 is rotatably coupled therewith. At the feeding start position (P) of the disk cable (a), the tip of the spear plate portion 35a is allowed to approach the tooth grooves 25c of the driving wheel 25 and the guide plate portion 35 is arranged between the tooth (g) of the driving wheel 25 and the disk 20 of the disk cable (a). The guide plate portion 35 is positioned to the angle position which blocks both of them and, thereafter, the supporting arm portion 34 is fixed to the bottom surface plate portion 14a of the corner cover 14 by the bolts 32.

Therefore, in the feed conveying apparatus (A) of the second embodiment having the above construction, upon operating, in each corner portion 12, the driving motor (m) of the cable driving unit 15 is individually made operative to thereby rotate each driving wheel 25, the same disk cable (a) is run in the pipe (p) by the driving motors (m) of the corner portions 12 in a sharing manner, respectively. Therefore, in the feed conveying apparatus (A) of the second embodiment using the driving load sharing system as mentioned above, the disk cable (a) runs in the pipe (p) with little load resistance. Thus, the conveying speed and conveyance amount of the feed which is conveyed by the disk cable (a) can be increased as compared with those in the single-driving unit system without using the large driving motors and irrespective of the length of pipeline by the pipe (p).

Moreover, in the feed conveying apparatus (A) of the second embodiment, when the driving wheel 25 is rotated in each corner portion 12 and the disk cable (a) is fed out of the tooth portion 25a of the outer circumference of the driving wheel 25, the feeding direction (S) of the disk cable (a) is always guided by the guide plate portion 35 of the looseness eliminating member (R) for such a period of time, and the looseness of the disk cable (a) is eliminated at the feeding start position (P). Even in the feed conveying apparatus (A) of the driving load sharing system, since no looseness is caused in the disk cable (a) at the feeding start position (P) in each corner portion 12 as mentioned above, such a conventional problem that the serious trouble occurs, that is, the loose portion of the disk cable (a) clings to the teeth (g) of the driving wheel 25, the disk cable is wound around the wheel, the situation of the cable snapping is caused, the feed conveyance inability occurs, and the like can be certainly eliminated. Therefore, even in the feed conveying apparatus (A) of the driving load sharing system, the inherent effect of increasing the conveying speed and conveyance amount of the feed which is conveyed by the disk cable (a) can be surely obtained owing to the looseness preventing effect of the disk cable (a).

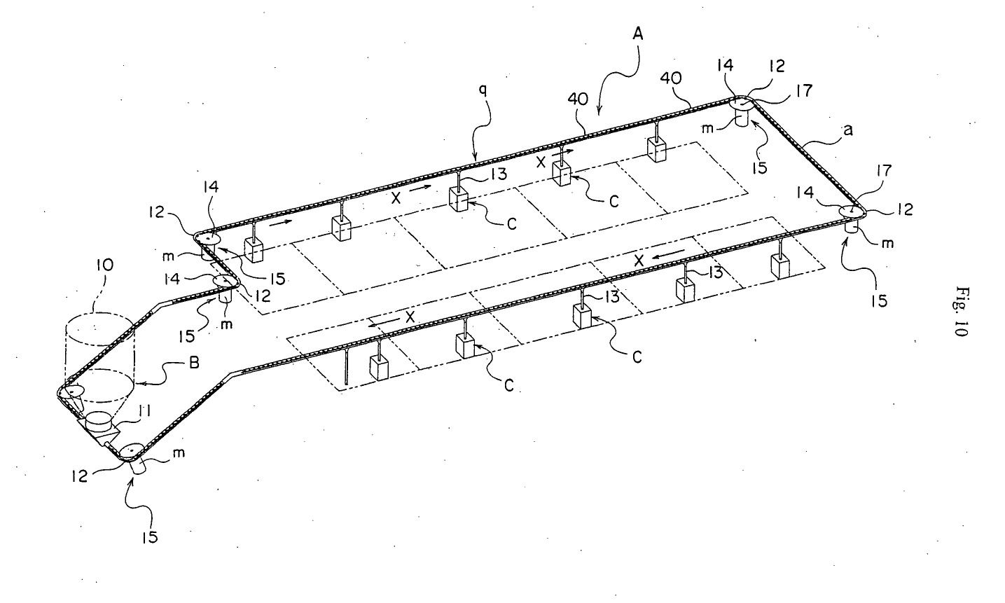

Subsequently, FIGS. 10 to 15 show the third embodiment of the best modes for carrying out the feed conveying apparatus according to the invention. The third embodiment shows a modification of the feed conveying path of the first embodiment and the cable driving unit 15 of the second embodiment. FIG. 10 shows a whole construction of a feed supplying system having the third embodiment of the feed conveying apparatus according to the invention. Therefore, in the third embodiment, the same constructing portions as those in the first and second embodiments are designated by the same reference numerals and will be explained hereinbelow.

Although a structure of the feed conveying apparatus (A) of the third embodiment is substantially the same as that of the second embodiment with respect to a point that the third embodiment uses the driving load sharing system in which the driving motor (m) of the cable driving unit 15 is provided in each corner portion 12, it is characterized by a gutter conveying system in which the endless feed conveying path is formed by a groove-shaped feed tub (q) whose upper side is opened.

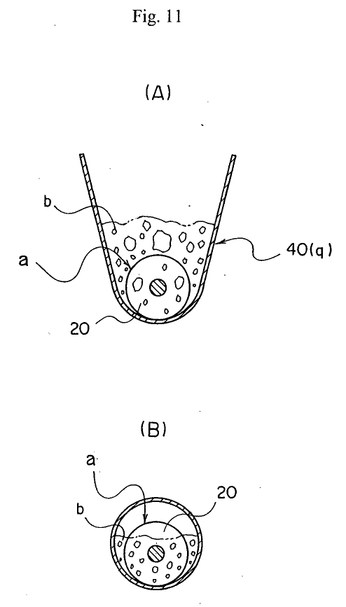

The feed tub (q) is made of a metal plate. As shown in FIG. 11(A), the feed tub (q) is molded into a gutter shape whose groove bottom portion is curved almost in a U-shape according to the disk shape of the disk cable (a). The whole structure of the feed tub (q) is as shown in FIG. 10. A straight tub portion is formed by coupling a plurality of tub-shaped rails 40. Each straight tub portion is coupled with the several corner portions 12, thereby forming the endless feed conveying path. The disk cable (a) is endlessly coupled and arranged in the feed conveying path whose upper side is opened.

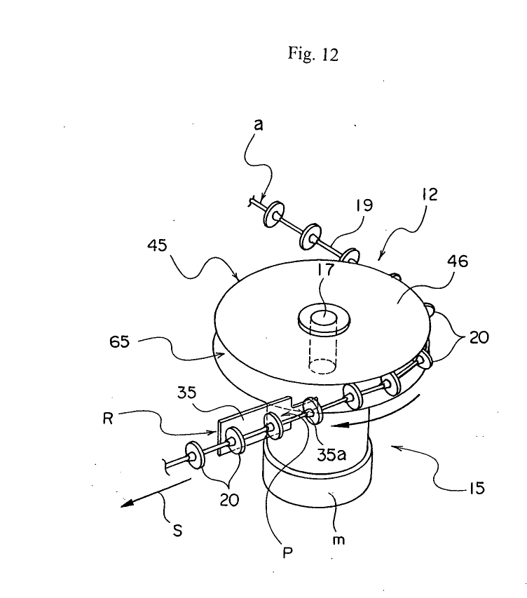

The cable driving unit 15 of the third embodiment has the following structure of the corner driving system. In a manner similar to the second embodiment, the driving motor (m) is externally attached to the bottom surface plate portion 14a of each circular corner cover 14, in the corner cover 14, a driving wheel 45 is directly coupled with the driving shaft 17 of the driving motor (m) and axially supported, as shown in FIG. 12, the disks 20 of the disk cable (a) are wound around the driving wheel 45, and the same disk cable (a) is rotated by the driving motors (m) of the corner portions 12 in a sharing manner.

Also in the third embodiment of the gutter conveying system, each cable driving unit 15 has a construction in which the looseness eliminating member (R) for guiding the feeding direction (S) of the disk cable (a) and eliminating its looseness is arranged at the feeding start position (P) of the driving wheel 45 where the disk cable (a) is fed out.

In the feed conveying apparatus (A) of the third embodiment, therefore, upon operating, in each corner portion 12, the driving motor (m) of the cable driving unit 15 is individually made operative to thereby rotate each driving wheel 25, the same disk cable (a) is run on the feed conveying path in the feed tub (q) by the driving motors (m) in a sharing manner, respectively. Therefore, in the feed conveying apparatus (A) of the third embodiment using the driving load sharing system as mentioned above, in a manner similar to the foregoing second embodiment, the disk cable (a) runs in the feed tub (q) with little load resistance. Thus, the conveying speed and conveyance amount of the feed which is conveyed by the disk cable (a) can be increased as compared with those in the single-driving unit system.

Moreover, in the feed conveying apparatus (A) of the third embodiment, since the feed conveying path is formed by the groove-shaped feed tub (q) whose upper side is open, when the feed is conveyed, as shown in FIG. 11(A), even if an amount of the feed which is conveyed by the disks 20 is large, the remaining feed can be saved into the upper gap space. Therefore, the area where the feed is strongly come into contact with the inner wall surface of the tub is small. Consequently, the frictional resistance is small according to such a small area and feed (b) can be smoothly conveyed through the feed conveying path. As shown in FIG. 11(B) for reference, unlike the third embodiment, in the case where the feed conveying path has a pipe structure, if an amount of the feed which is conveyed in the pipe by the disks 20 is large, there is no space where the remaining feed escapes. Therefore, since the feed is strongly come into contact with the inner surface of the pipe and subjected to the large frictional resistance, it is difficult to smoothly convey the feed. Moreover, since the apparatus has an airtight structure without an open portion, the conveyance amount of the feed is restricted and small and the conveying efficiency deteriorates. However, with respect to this point, in the feed conveying apparatus (A) of the third embodiment, since the feed conveying path is formed by the feed tub (q) whose upper side is open as mentioned above, as compared with the case where the feed conveying path is formed by the pipe structure, the feed (b) can be efficiently and smoothly conveyed and the feed conveyance amount can be further increased. In addition, since the feed conveying path is formed by the feed tub (q) whose groove bottom portion has a curved shape according to the disk shape of the disk cable (a), the radius size of the disk 20 is not limited but the disk cables (a) having the disks of various large and small sizes can be used.

Moreover, in the feed conveying apparatus (A) of the third embodiment, when the driving wheel 25 is rotated in each corner portion 12 and the disk cable (a) is fed out of the tooth portion of the outer circumference of the driving wheel 25, the feeding direction (S) of the disk cable (a) is always guided by the guide plate portion 35 of the looseness eliminating member (R) for such a period of time, and the looseness of the disk cable (a) is eliminated at the feeding start position (P). Therefore, even in the feed conveying apparatus (A) of the gutter conveying system, since no looseness is caused in the disk cable (a) at the feeding start position (P) in each corner portion 12 as mentioned above, such a conventional problem that the serious trouble occurs, that is, the loose portion of the disk cable (a) clings to the teeth of the driving wheel, the disk cable is wound around the wheel, the feed conveyance inability and the like occur, can be certainly eliminated. Thus, even in the feed conveying apparatus (A) of the gutter conveying system, the inherent effect of further increasing the conveying speed and conveyance amount of the feed which is conveyed by the disk cable (a) can be surely obtained owing to the looseness preventing effect of the disk cable (a).

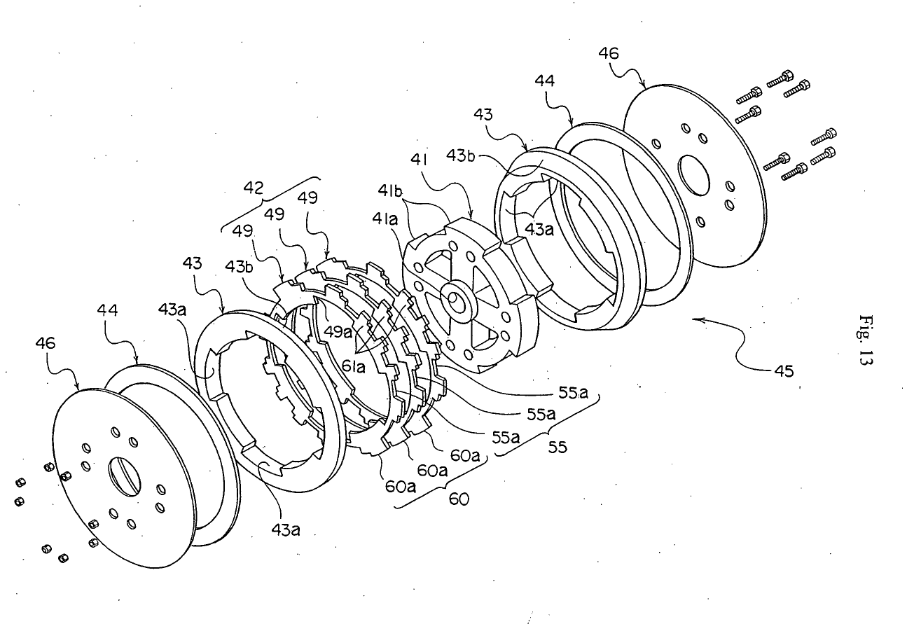

In the feed conveying apparatus (A) of the gutter conveying system of the third embodiment, although the cable driving system is the same driving load sharing system as that of the second embodiment, particularly, as a modification of the driving wheels 25 in the first and second embodiments, the driving wheel 45 has a gear wheel structure of a pad driving system as shown in FIGS. 13 to 15.

As shown in FIG. 13, the driving wheel 45 of the third embodiment comprises: an annular boss 41 having an attaching through hole 41a of the driving shaft 17 at the center and fitting projecting portions 41b on the outer circumference; a rim 42 which is fitted to the outer circumference of the boss 41; a pair of ring-shaped elastic pads 43 which sandwich the rim 42 and are fitted to the outer circumference of the boss 41; a pair of ring-shaped outer spacer plates 44 which sandwich the elastic pads 43 and are attached; and a pair of doughnut-shaped attaching disks 46 which sandwich those component elements and are attached to the outermost sides.

The rim 42 has a plurality of ring-shaped spacer plates 49 made of a metal having an equal thickness. Each spacer plate 49 is press-molded into the same shape in which fitting concave portions 49a corresponding to the fitting convex portions 41b of the boss 41 are formed on an inner circumference and concave portions 55a and convex portions 60a are alternately formed on the outer circumference at regular intervals. A retaining step portion 61a in which one side of the rim circumferential direction is convex in the circumferential direction is formed in the convex portion 60a so as to be projected therefrom. In the example shown in the diagram, each elastic pad 43 is made of rubber. Fitting concave portions 43a corresponding to the fitting convex portions 41b of the boss 41 are formed on an inner circumference and a taper surface 43b having an arc-shaped cross section is formed on an outer circumference in correspondence to the disk 20.

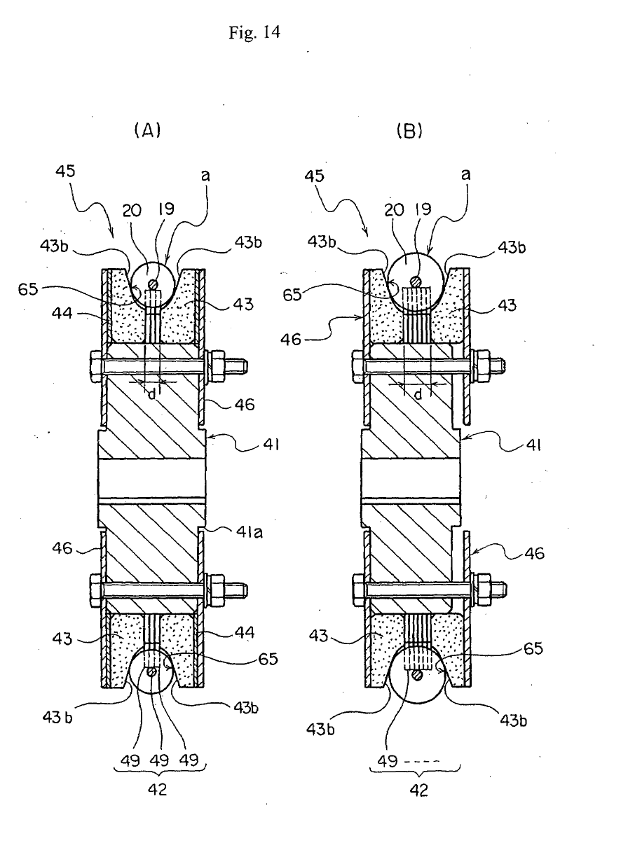

According to the driving wheel 45 having such a parts construction, in the example shown in the diagram, three spacer plates 49 are fitted onto the outer circumference of the boss 41 by mutually fitting the concave and convex portions and mutually overlaid, thereby forming a single laminated rim 42. Subsequently, the elastic pads 43 sandwich the laminated rim 42 and are fitted to the outer circumference of the boss 41 from both sides of the laminated rim 42 by mutually fitting the concave and convex portions so that their taper surfaces 43b face each other. The elastic pads 43 are sandwiched between the attaching disks 46 through the outer spacer plates 44, detachably fixed to the boss 41 by bolts and nuts, and assembled as shown in FIG. 14(A).

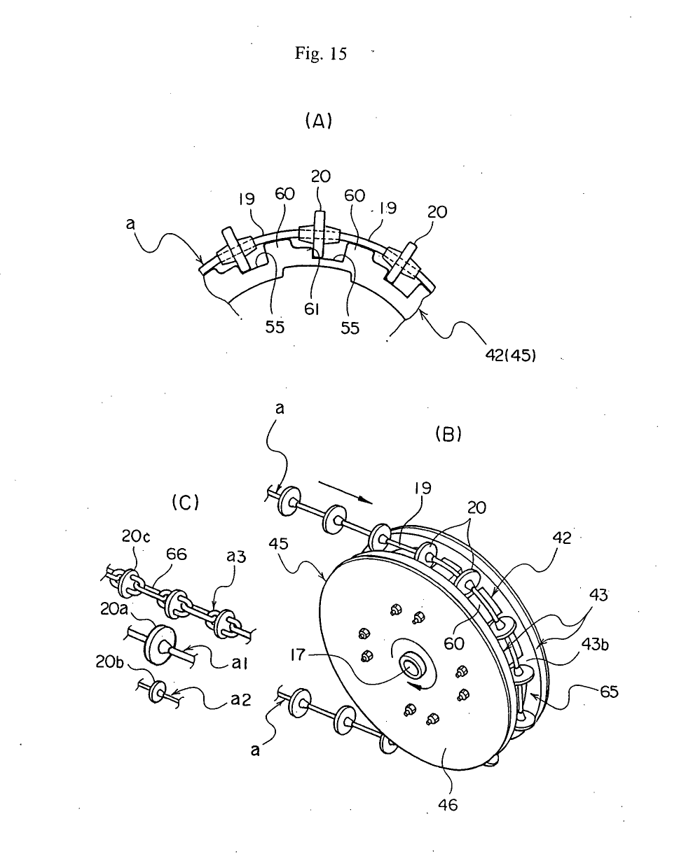

Therefore, in the assembled driving wheel 45, as shown in FIG. 15(A), concave surface portions 55 on which the disks 20 in the standing state are put when the disk cable (a) is wound and convex portions 60 on which cable portion 19 between the adjacent conveying disks 20 is put and held are alternately formed on the outer circumference of the laminated rim 42 at regular intervals. A retaining step portion 61 with which the disk 20 of the disk cable (a) is come into contact when the disk cable is fed is formed on the lower portion side of the convex portions 60.

Further, in the assembled driving wheel 45, as shown in FIG. 14(A), a disk guide groove 65 having a circular cross section which the disk 20 of the disk cable (a) can bite by the taper surfaces 43b which face each other is formed on the outer circumferential surface of the elastic pad 43. As shown in FIG. 15(B), the disk cable (a) is wound around the driving wheel 45 in the state where each disk 20 is fitted into the disk guide groove 65 of the elastic pad 43.

In the feed conveying apparatus (A) of the third embodiment, upon operating, the disk cable (a) is run in the endless feed tub (q) while being strongly stretched without a looseness. In the cable driving unit 15, however, as shown in FIG. 15(B), the disks 20 are perpendicularly put onto the concave surface portions 55 of the laminated rim 42 of the driving wheel 45, the cable portion 19 between the disks 20 is put and held onto the convex portions 60, and in the cable portion 19, the disk cable is rotated while being supported at three points among the convex portion 60 and the two concave surface portions 55 and 55. Therefore, the disk cable (a) is smoothly corner-driven while drawing an arc that is concentrical with the laminated rim 42 without locally being bent even around the driving wheel 45, that is, without being subjected to a bending load at any place of the cable portion 19.

Since the disk cable (a) is rotated while each disk 20 is fitted into the disk guide groove 65 of the elastic pad 43 and bites it, the disk cable runs smoothly without being hooked or slipping on the way.

According to the feed conveying apparatus (A) of the third embodiment, in the driving wheel 45, the rim 42 and the elastic pad 43 are detachably fastened to the boss 41 as mentioned above. Therefore, in the rim 42, an interval (d) [refer to FIGS. 14(A) and 14(B)] between the elastic pads 43 and 43 which the disk 20 is allowed to bite can be adjusted by increasing or decreasing the number of spacer plates 49 which are fitted into the boss 41 in accordance with the radius size of the disk 20 of the disk cable (a).

In the third embodiment, therefore, when the size of the disk 20 of the disk cable (a) is equal to a medium radius size as shown in the example of the diagram, it is assumed that the rim 42 has the laminated structure having a thickness corresponding to the three spacer plates 49 fitted into the boss 41 in accordance with the medium size. However, in the case of using a disk cable (a1) having disks 20a of a large radius size which is larger than the medium radius size by one stage as shown in FIG. 15(C), the number of spacer plates 49 which are fitted into the boss 41 is increased to five in accordance with the large radius size, the interval (d) between the elastic pads 43 and 43 is adjusted to the width size at which the disks 20a of the large radius size can bite, and the interval (d) is widened by such a width size as shown in FIG. 14(B). On the contrary, in the case of using a disk cable (a2) having disks 20b of a small radius size which is smaller than the medium radius size by one stage as shown in FIG. 15(C), the number of spacer plates 49 which are fitted into the boss 41 is decreased in accordance with the small radius size, the interval (d) between the elastic pads 43 and 43 is adjusted to the width size at which the disks 20a of the small radius size can bite, and the interval (d) is narrowed by such a width size.

On the other hand, in the third embodiment, as shown in FIG. 15(C), a chain-type disk cable (a3) in which disks 20c are assembled at regular intervals by penetrating a chain 66 through the centers of the disks may be wound around the driving wheel 45 and used in a manner similar to the wire-type disk cable (a). Also in this case, similarly, if the interval (d) between the elastic pads 43 and 43 which the disk 20c is allowed to bite is adjusted by increasing or decreasing the number of spacer plates 49 which are fitted into the boss 41 in accordance with the radius size of the disk 20c of the chain-type disk cable (a3), the chain-type disk cable (a3) can be wound as it is around the same driving wheel 45 and used.

Further, according to the feed conveying apparatus (A) of the third embodiment, in the driving wheel 45, when the disk guide groove 65 of the elastic pad 43 is abraded with the elapse of time, the elastic pad 43 is temporarily detached from the boss 41, the spacer plates 49 of the necessary number are pulled out in accordance with a degree of the abrasion of the disk guide groove 65, and the interval (d) between the elastic pads 43 and 43 of the disk guide groove 65 is adjusted. Upon driving of the disk cable (a), the interval (d) can be adjusted in such a manner that when the disk 20 passes through the disk guide groove 65 of the driving wheel 45, the disk is always fitted into the disk guide groove 65 and smoothly bites it without slipping, and a driving force is accurately transferred.

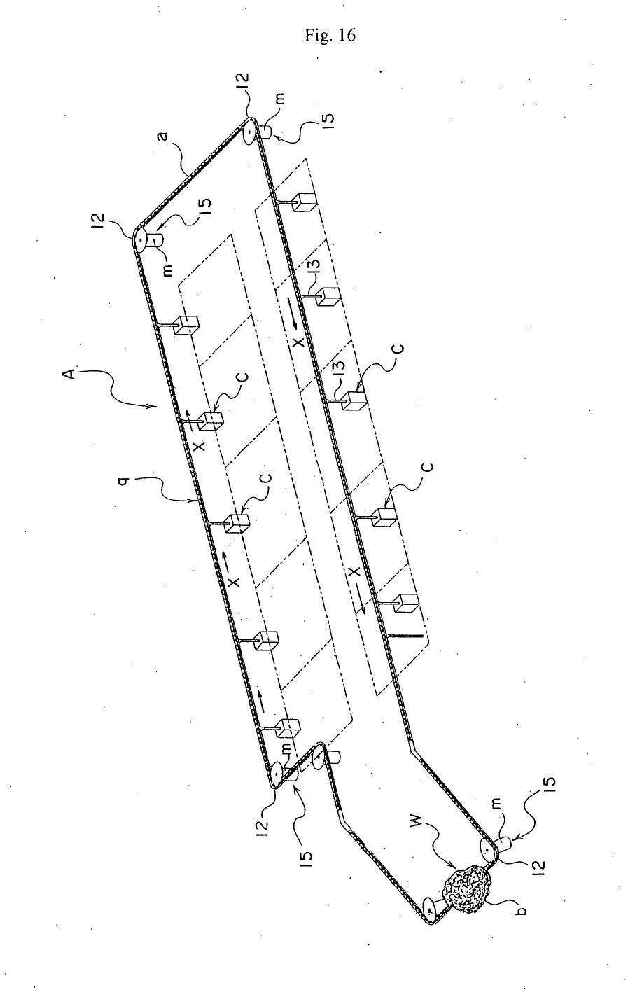

Subsequently, FIG. 16 shows the fourth embodiment of the best modes for carrying out the feed conveying apparatus according to the invention. The fourth embodiment shows a further modification of the feed conveying path equipped for the feed conveying apparatus (A) of the gutter conveying system of the third embodiment. FIG. 16 shows a whole construction of the feed supplying system having the feed conveying apparatus (A) of the fourth embodiment. Therefore, in the fourth embodiment, the same constructing portions as those in the third embodiment are designated by the same reference numerals and will be explained hereinbelow.

In the feed tub (q) constructing the feed conveying path of the fourth embodiment, a feed inserting position (W) corresponding to the setting position of the feed supplying apparatus (B) is set to a low height position where the feed (b) can be manually directly inserted from an upper position into the feed conveying path in the first to third embodiments.

Therefore, according to the fourth embodiment, since the feed tub (q) has a groove shape in which the feed conveying path is opened upwardly, the construction in which the feed supplying apparatus (B) is set to the feed inserting position (W) as shown in the first to third embodiments is unnecessary. The feed (b) can be supplied by directly inserting the feed into the feed tub (q) by proper means as shown in the diagram. Moreover, as feed (b), besides the coarse feed of large particles and grain feed of small particles, powder feed may be used. The invention is not limited to their dry feed but can also use a paste bait (liquid feed) or the like. The kind of feed is not limited but any kind of feed can be directly inserted into the feed tub (q) and conveyed. Even the feed obtained by refining raw garbage such as dregs of bean curd (TOFU) or the like can be inserted and conveyed.

In the gutter-type feed conveying apparatus (A) of each of the third and fourth embodiments mentioned above, the same driving load sharing system as that in the second embodiment is used as a driving system of the disk cable (a). However, naturally, the case of the single-driving unit system in which one cable driving unit 15 is used as shown in the first embodiment is not excluded.

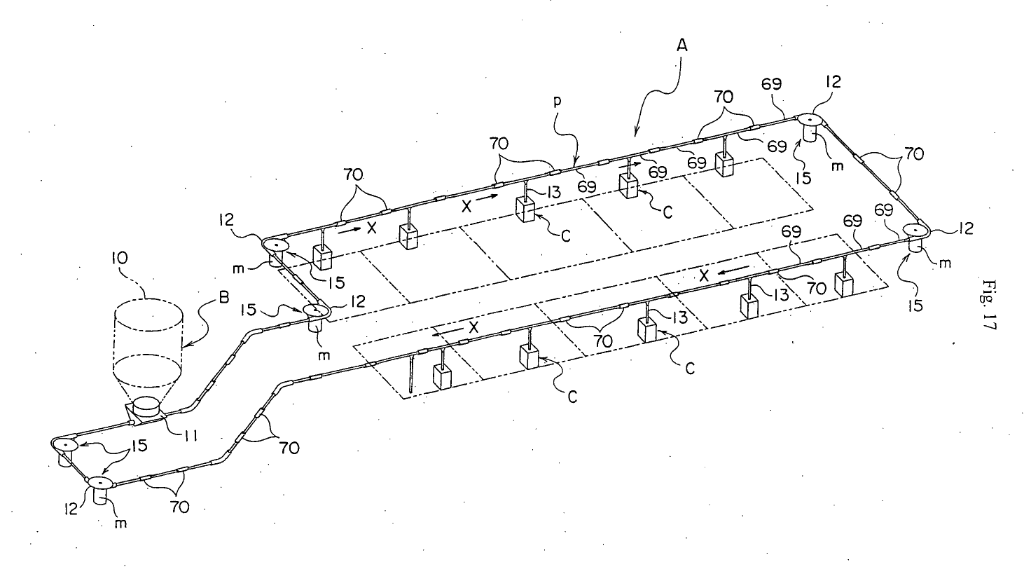

Subsequently, FIGS. 17 to 21 show the fifth embodiment of the best modes for carrying out the feed conveying apparatus according to the invention. The fifth embodiment shows a modification of the feed conveying path of the pipe system of the second embodiment. FIG. 17 shows a whole construction of the feed supplying system having the fifth embodiment of the feed conveying apparatus according to the invention. Therefore, in the fifth embodiment, the same constructing portions as those in the second embodiment are designated by the same reference numerals and will be explained hereinbelow.

The feed conveying apparatus (A) of the fifth embodiment is similar to that in the second embodiment in terms of a point that the cable driving system is the driving load sharing system in which the cable driving unit 15 is provided in each corner portion 12, and the feed conveying system uses the pipe conveying structure in which the feed conveying path is formed by the pipe (p) obtained by endlessly connecting a plurality of conveying pipes 69 and the endless disk cable (a) is arranged in the pipe (p). However, the feed conveying apparatus (A) of the fifth embodiment is characterized by a construction in which the conveying pipe 69 of the pipe (p) is equipped with a cable pressing metal fitting 70 for guiding the disk cable (a) along a bottom surface portion in the pipe (p) while suppressing the floating of the disk cable (a) running in the pipe (p) from an upper position in the conveying pipe 69.

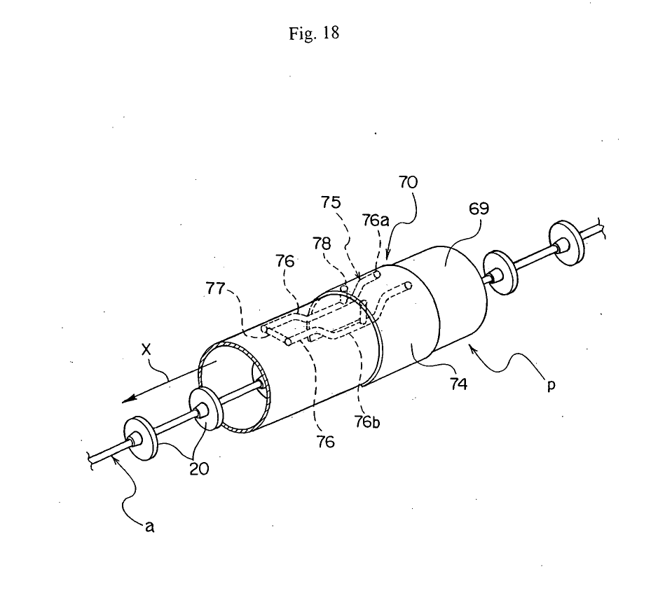

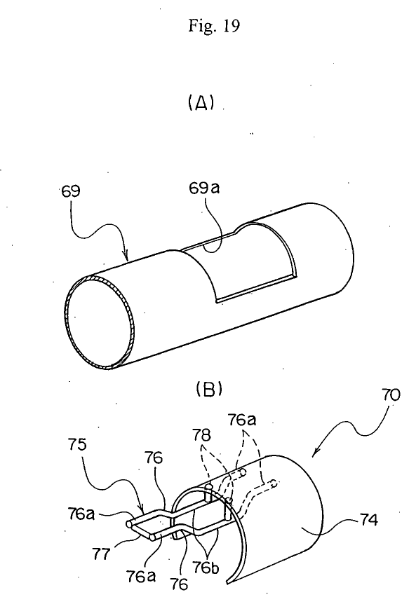

As shown in FIG. 18, the cable pressing metal fitting 70 of the fifth embodiment is attached so as to hold the outer circumference of the conveying pipe 69. As shown in FIG. 19(A), a notched hole 69a is formed in the conveying pipe 69 at an upper metal fitting attaching position of the circumferential surface of the pipe. As shown in FIG. 19(B), the cable pressing metal fitting 70 comprises: an attaching cover 74 which is formed by bending and molding a metal plate in accordance with the circumferential surface shape of the conveying pipe 69 and has an arc pipe shape whose circumferential length is longer than that of a semicircle; and a pressing rod member 75 which is fixed to the inner circumferential surface of the attaching cover 74. The pressing rod member 75 has a pair of pressing round rods 76 which are assembled by using a round rod material, bent at positions near both end portions 76a, and bent and molded so that pressing shaft portions 76b are formed in the convex shape between the both end portions 76a. A pin-shaped coupling rod 77 is welded between one end of one of the pressing round rods 76 and one end of the other pressing round rod 76. The pressing round rods 76 are arranged in parallel and coupled. One end of a pin-shaped supporting rod 78 is welded to each pressing shaft portion 76b so as to stand thereon. The cable pressing metal fitting 70 is constructed in such a manner that the other end of the supporting rod 78 and the other end of the pressing round rod 76 are welded to the inner circumferential surface of the attaching cover 74, and the pressing rod member 75 is assembled to the attaching cover 74 in the state where the pressing shaft portion 76b faces downwardly and the coupling rod 77 side is exposed from the attaching cover 74.

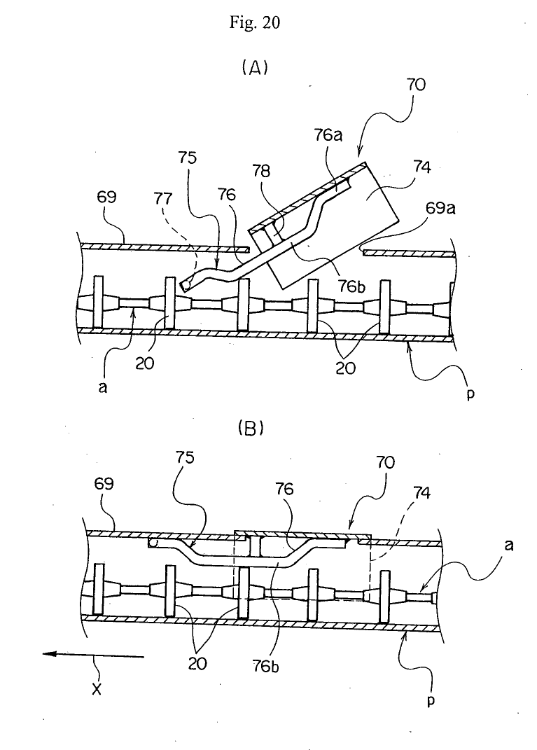

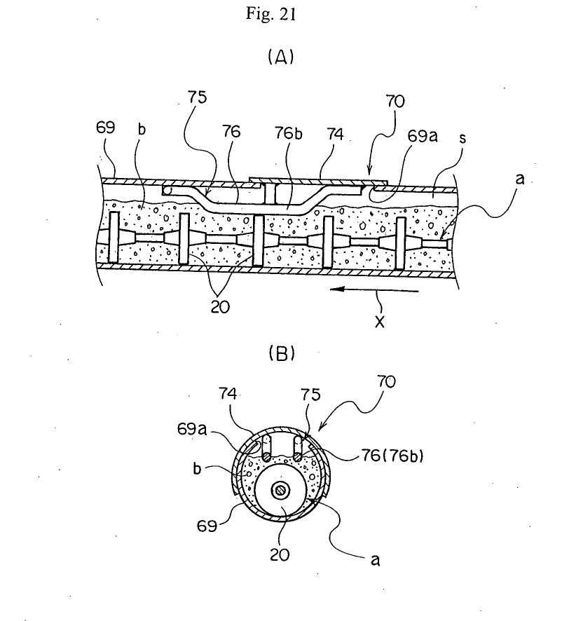

As for the cable pressing metal fitting 70 according to the fifth embodiment as mentioned above, as shown in FIG. 20(A), the coupling rod 77 side of the pressing rod member 75 is inserted from the notched hole 69a of the conveying pipe 69, the attaching cover 74 is temporarily pressed and opened against spring performance and, thereafter, held around the outer circumference of the conveying pipe 69, and detachably attached to the conveying pipe 69 as shown in FIG. 20(B). Thus, the cable pressing metal fitting 70 is assembled to the conveying pipe 69 in the state where the pressing shaft portions 76b of the pressing rod member 75 are inserted onto the disk cable (a) along the cable running direction (X) in the pipe (p). In this manner, the cable pressing metal fitting 70 has the structure in which, as shown in FIG. 17, the cable pressing metal fittings 70 are attached onto the pipe (p) at almost regular intervals of, for example, 1 m and, in the pipe (p), the floating of the disk cable (a) running in the pipe (p) is suppressed by the pressing rod member 75 from the upper position in the conveying pipe 69 as shown in FIG. 21.

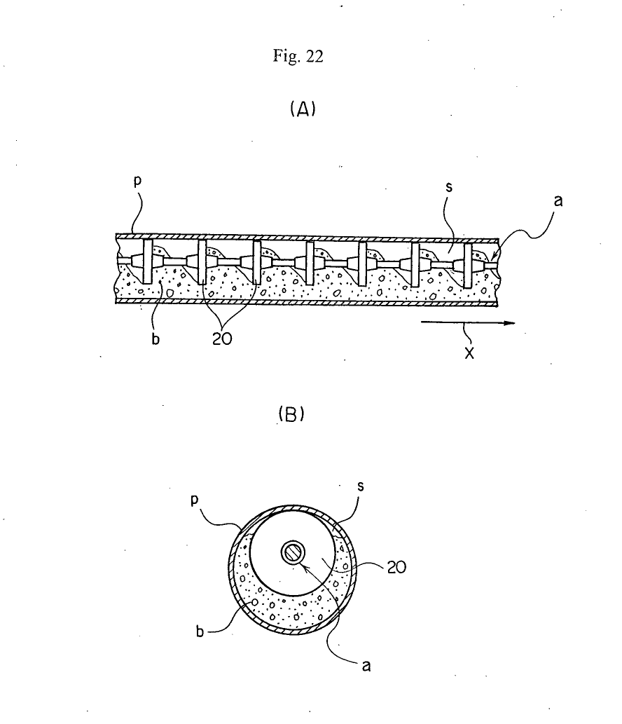

Therefore, in the case of conveying the feed (b) by running the disk cable (a) in the pipe (p), if the feed conveyance amount increases, as shown in FIG. 22 for reference, generally, there is a tendency that the disk cable (a) is pressed by a flow of the feed (b) in the pipe (p), escapes dynamically toward a gap (s) side formed in the upper portion in the pipe (p), and is floated up. Therefore, if the disk cable (a) runs continuously in the pipe (p) in the floating state, only the surface layer side of the feed (b) is partially conveyed in the pipe (p), so that a large amount of feed (b) is left on the bottom side in the pipe (p) and a feed jam occurs. Thus, the feed of the feed jam is solidified with the elapse of time. Such a bundle of feed becomes a large load resistance of the running of the disk cable (a) and there is a case where such a situation that the disk cable (a) is snapped due to the bundle of feed occurs. Moreover, the feed (b) is generally obtained by mixing the coarse particles of various diameters and fine components such as additives containing various nutritional elements and the like. If only the surface layer side of the feed (b) is partially conveyed in the pipe (p) as mentioned above, a problem (separation of the feed) that the coarse particles of the surface layer side and the fine components remaining on the bottom side are separated occurs and the conveying efficiency is remarkably deteriorated. In addition, a problem that it is unsanitary and which is serious to the feed conveying apparatus occurs.

However, according to the feed conveying apparatus (A) of the fifth embodiment, upon operating, in each corner portion 12, the driving motor (m) of the cable driving unit 15 is driven to thereby allow the disk cable (a) to run in the pipe (p) in a sharing manner and the feed (b) is conveyed. At this time, even if the disk cable (a) is pressed by the flow of the feed (b) and is floated upward in the pipe (p), the floating of the disk cable (a) is suppressed by the pressing rod member 75 of the cable pressing metal fitting 70 from the upper position in the conveying pipe 69 as shown in FIG. 21 and the disk cable is guided so as to run along the bottom surface portion in the pipe (p).

Therefore, according to the feed conveying apparatus (A) of the fifth embodiment, upon operating, all of the feed (b) is conveyed without leaving the feed (b) even on the bottom side in the pipe (p), so that the occurrence of the feed jam is perfectly eliminated and the trouble such as snapping or the like of the disk cable (a) does not occur. Moreover, the conveying efficiency can be remarkably improved without causing the problem of the feed separation. The sanitary problem can be also eliminated. In this instance, in the cable pressing metal fitting 70 of the fifth embodiment, the pressing rod member 75 is assembled by using the elongated round rod member, and in the pipe (p), the cable pressing metal fitting 70 is assembled to the conveying pipe 69 in the state where the pressing rod member 75 is inserted onto the disk cable (a) along the cable running direction (X) in which the feed (b) is conveyed. Therefore, the situation where the pressing rod member 75 becomes the resistance and obstructs the conveyance of the feed (b) does not occur and the floating suppressing function of the disk cable (a) can be effectively performed.

In the feed conveying apparatus (A) of the fifth embodiment mentioned above, the driving load sharing system is used as a driving system of the disk cable (a). However, naturally, the case of the single-driving unit system in which one cable driving unit 15 is used as shown in the first embodiment is not excluded.

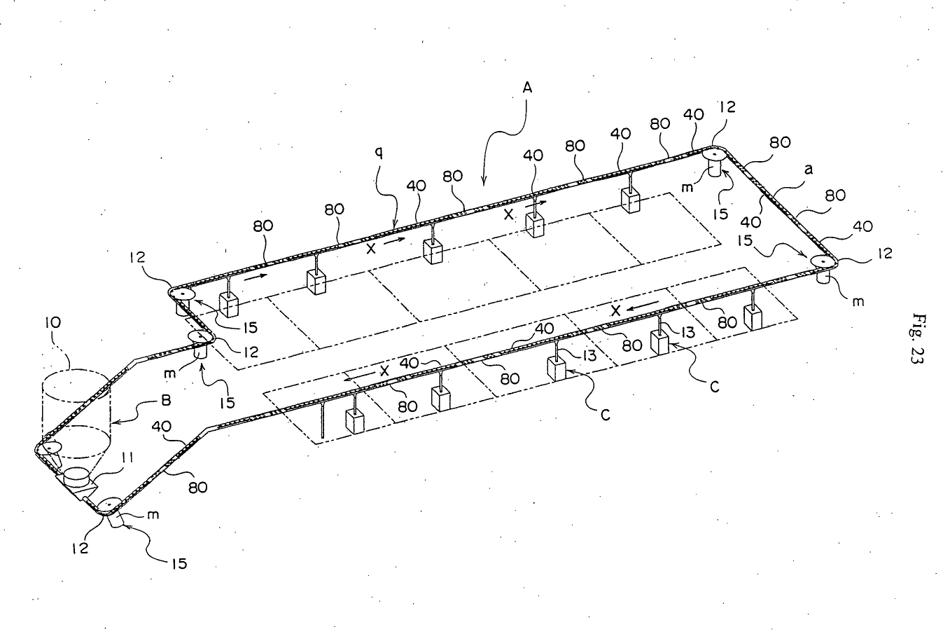

Subsequently, FIGS. 23 to 25 show the sixth embodiment of the best modes for carrying out the feed conveying apparatus according to the invention. The sixth embodiment shows a modification of the gutter-type feed conveying path of the third embodiment. FIG. 23 shows a whole construction of the feed supplying system having the sixth embodiment of the feed conveying apparatus according to the invention. Therefore, in the sixth embodiment, the same constructing portions as those in the third embodiment are designated by the same reference numerals and will be explained hereinbelow.

The feed conveying apparatus (A) of the sixth embodiment is similar to that in the third embodiment in terms of a point that the cable driving system is the driving load sharing system in which the cable driving unit 15 is provided in each corner portion 12 and the feed conveying system uses the gutter conveying structure in which the feed conveying path is formed by the feed tub (q) obtained by endlessly connecting the tub-shaped rails 40 having a gutter shape in each of which an upper side is open and the endless disk cable (a) is arranged in the feed tub (q). However, the feed conveying apparatus (A) of the sixth embodiment is characterized by a structure in which each of the tub-shaped rails 40 forming the feed tub (q) is equipped with a cable pressing metal fitting 80 for guiding the disk cable (a) along a groove bottom surface in the feed tub (q) while suppressing the floating of the disk cable (a) running in the feed tub (q) from an upper position of the tub-shaped rail.

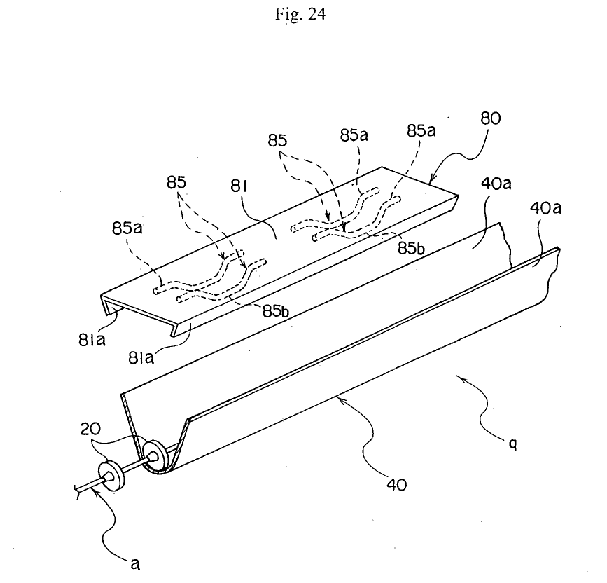

As shown in FIG. 24, the cable pressing metal fitting 80 of the sixth embodiment comprises: an attaching cover 81 having an external size corresponding to the shape of the upper opening portion of the tub-shaped rail 40; and two sets of pressing rods 85 fixed to the attaching cover 81. The attaching cover 81 is made of a rectangular metal plate, both side edges in the width direction of the metal plate are bent at an angle so as to inwardly face each other, and sandwiching members 81a are bent and molded at both side edges, respectively. The pressing rod 85 of each set is made of a round rod and bent and molded at positions near both end portions 85a so that a pressing shaft portion 85b is formed so as to be convex between the both end portions 85a. The both end portions 85a are welded to the inner surface having the sandwiching members 81a of the attaching cover 81 and the two pressing rods 85 of each set are fixed in parallel.

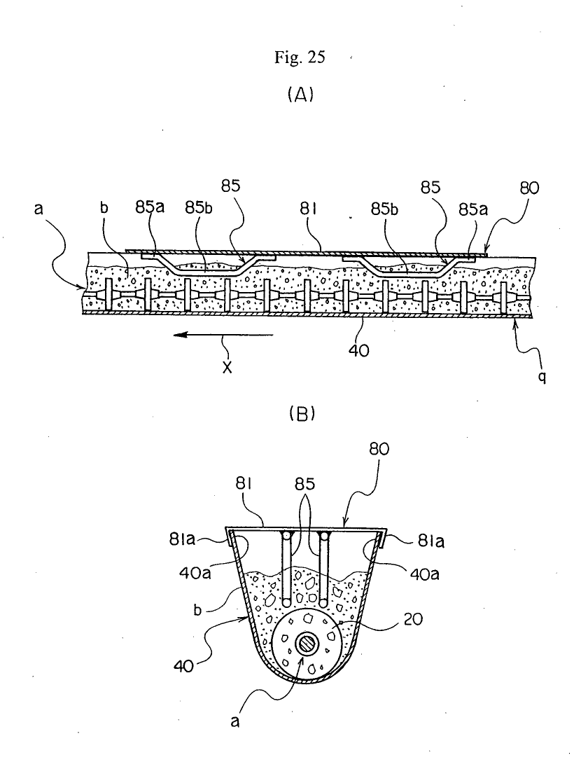

In the cable pressing metal fitting 80, the attaching cover 81 having the downward pressing rods 85 is covered onto the upper opening portion of the tub-shaped rail 40. In this instance, the attaching cover 81 is come into engagement with open side upper edges 40a on both sides of the tub-shaped rail 40 in the state where the sandwiching members 81a are slightly opened against the spring performance. The attaching cover 81 is covered onto the tub-shaped rail 40 so as to sandwich the open side upper edges 40a and detachably attached to the rail. Thus, as shown in FIG. 25, the cable pressing metal fitting 80 is assembled onto the tub-shaped rail 40 in the state where the pressing shaft portions 85b of the parallel pressing rods 85 are inserted onto the disk cable (a) along the cable running direction (X) in the feed tub (q). In this manner, the cable pressing metal fitting 80 has the structure in which the metal fittings are arranged on the endless feed tub (q), for example, at almost regular intervals as shown in FIG. 23 and, in the feed tub (q), the floating of the disk cable (a) running in the feed tub (q) is suppressed by the pressing rods 85 from the upper position in the tub-shaped rail 40 as shown in FIG. 25.

Therefore, in the case of conveying the feed by running the disk cable (a) in the feed tub (q), since the feed tub (q) has the shape in which the upper portion is open, generally, if the feed conveyance amount increases, the disk cable (a) is pressed by the flow of the feed (b) in the feed tub (q), escapes dynamically toward the upper open side of the feed tub (q), and is floated up like an arch in accordance with circumstances. Therefore, if the disk cable (a) runs continuously in the feed tub (q) in the floating state, only the surface layer side of the feed (b) is partially conveyed in the feed tub (q) in a manner similar to the case of the fifth embodiment mentioned above, so that a large amount of feed (b) is left on the bottom side in the feed tub (q) and a feed jam occurs. Thus, the feed of the feed jam is solidified with the elapse of time. Such a bundle of feed becomes a large load resistance of the running of the disk cable (a) and there is a case where such a situation that the disk cable (a) is snapped due to the bundle of feed occurs. Moreover, if only the surface layer side of the feed (b) is partially conveyed in the feed tub (q) as mentioned above, such a problem of the feed separation that the coarse particles of the surface side and the nutritional components such as fine additives and the like which are left on the groove bottom side are separated occurs in a manner similar to the case of the fifth embodiment. The serious problem that the conveying efficiency is low and it is unsanitary occurs.

However, according to the feed conveying apparatus (A) of the sixth embodiment, upon operating, in each corner portion 12, the driving motor (m) of the cable driving unit 15 is driven to thereby allow the disk cable (a) to run in the feed tub (q) in a sharing manner and the feed (b) is conveyed. However, at this time, even if the disk cable (a) is pressed by the flow of the feed (b) and is floated upward in the feed tub (q), the floating of the disk cable (a) is suppressed by the pressing rods 85 of the cable pressing metal fitting 80 from the upper position of the tub-shaped rail 40 as shown in FIG. 25 and the disk cable (a) is guided so as to run along the groove bottom surface in the feed tub (q).

Therefore, according to the feed conveying apparatus (A) of the sixth embodiment as well, upon operating, all of the feed (b) is conveyed by the disk cable (a) without leaving the feed (b) on the groove bottom side in the feed tub (q), so that the occurrence of the feed jam is perfectly eliminated and the trouble such as snapping or the like of the disk cable (a) does not occur. Moreover, the problem of the feed separation does not occur. The conveying efficiency can be remarkably improved. The sanitary problem can be also eliminated. In this instance, in the cable pressing metal fitting 80 of the sixth embodiment, the pressing rods 85 are made of the elongated round rods and assembled to the tub-shaped rail 40 in the state where they are inserted onto the disk cable (a) along the cable running direction (X) in which the feed (b) is conveyed in the feed tub (q). Therefore, the situation where the pressing rods 85 become the resistance and obstruct the conveyance of the feed (b) does not occur and the floating suppressing function of the disk cable (a) can be effectively performed.

In the feed conveying apparatus (A) of the sixth embodiment mentioned above, the same driving load sharing system as that in the second to fifth embodiment is used as a driving system of the disk cable (a). However, naturally, the case of the single-driving unit system in which one cable driving unit 15 is used as shown in the first embodiment is not excluded.

The invention is not limited to the fields of the breeding cows, pig farming, or chicken farming and can be widely applied to a field of the feed conveyance in which various kinds of feed are conveyed by driving the disk cable.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1. A feed conveying apparatus constructed in such a manner that a disk cable to which a number of feed conveying disks are assembled at regular intervals by penetrating a cable through centers of said disks is endlessly suspended and arranged in a feed conveying path formed endlessly by providing a plurality of corner portions in accordance with a setting layout of feed suppliers, each of said disks is come into engagement with a tooth of a driving wheel equipped for a cable driving unit and said disk cable is wound around said driving wheel, and said driving wheel is driven by a driving motor supported by a driving shaft, thereby conveying the feed while running said disk cable along said feed conveying path,
wherein said cable driving unit has a looseness eliminating member for guiding a feeding direction of said disk cable and eliminating a looseness at a feeding start position where said disk cable is fed out from a tooth portion of an outer circumference of said driving wheel toward the downstream side in a tangential direction, and
said looseness eliminating member comprises: a guide plate portion which blocks between the teeth of said driving wheel and the disks of said disk cable at said feeding start position; and a supporting arm portion which is rotatably come into engagement with said driving shaft and coaxially coupled therewith and attaches said guide plate portion to said cable driving unit so that a guide angle position of said guide plate portion can be adjusted in accordance with the feeding direction of said disk cable.

2. A feed conveying apparatus according to claim 1, wherein said feed conveying path is formed by an endless pipe constructed by connecting a plurality of conveying pipes, said disk cable which is endlessly coupled is inserted in said pipe, and said conveying pipe has a cable pressing metal fitting for guiding said disk cable along a bottom surface portion in said pipe while suppressing floating of said disk cable running in said pipe from an upper position in the conveying pipe.

3. A feed conveying apparatus according to claim 2, wherein a notched hole is formed in said conveying pipe at an attaching position of said cable pressing metal fitting, said cable pressing metal fitting comprises an arc-pipe-shaped attaching cover which is detachably attached to said conveying pipe so as to be wound around an outer circumference thereof and a pressing rod member made of a round rod which is fixed onto an inner circumferential surface of said conveying pipe, and said pressing rod member is bent and molded in a convex shape so as to be inserted through said notched hole along a cable running direction over said disk cable in said conveying pipe when said attaching cover is attached to said conveying pipe.

4. A feed conveying apparatus according to claim 1, wherein said feed conveying path is formed by a gutter-shaped feed tub which has a groove shape whose upper side is opened and whose groove bottom portion is curved in accordance with a disk shape of said disk cable.

5. A feed conveying apparatus according to claim 4, wherein said feed conveying path formed by said feed tub is constructed so that a feed inserting position is set to a height position where the feed can be manually directly inserted from an upper position into said feed conveying path.

6. A feed conveying apparatus according to claim 4 or 5, wherein said feed conveying path is formed by an endless feed tub constructed by connecting a plurality of tub-shaped rails, said disk cable connected endlessly is arranged in said feed tub, and said tub-shaped rail has a cable pressing metal fitting which is put on the tub-shaped rail and attached thereto and guides said disk cable along a groove bottom surface in said feed tub while suppressing floating of said disk cable running in said feed tub.

7. A feed conveying apparatus according to claim 6, wherein said cable pressing metal fitting comprises an attaching cover which is come into engagement with open side upper edges of said tub-shaped rail and detachably covered thereon and pressing rods which are made of round rods and fixed onto the inner surface of said attaching cover, and said pressing rods are bent and molded into a convex shape so as to be inserted along the cable running direction over said disk cable in said tub-shaped rail when said attaching cover is covered onto said tub-shaped rail.

8. A feed conveying apparatus according to claim 1, wherein said cable driving units are positioned in the corner portions of said feed conveying path, in each cable driving unit in each corner portion, the disks of said disk cable are come into engagement with the teeth of said driving wheel and said disk cable is wound around the driving wheel, and said disk cable is corner-driven by each of said driving motors.

9. A feed conveying apparatus according to claims 1, wherein said driving wheel is constructed in such a manner that concave surface portions on which each disk is put in a standing state and convex portions on which a cable portion between the disks is put and held when said disk cable is wound around each of said driving wheels are alternately formed on the outer circumference of each rim, in said cable portion between said disks, said disk cable is supported at three points among said convex portion and said two concave surface portions and is wound in an arc shape which is concentric with said rim outer circumference.

10. A feed conveying apparatus according to claim 9, wherein said driving wheel is constructed in such a manner that said rim and a pair of ring-shaped elastic pads which are coaxially arranged so as to sandwich said rim are detachably fitted to an outer circumference of a boss, respectively, a taper surface having an arc-shaped cross section is formed on an outer circumference of each of said elastic pads, when said taper surfaces are fitted into said boss so as to face each other, a disk guide groove having a circular cross section with which the disks of said disk cable wound around said driving wheel can be come into engagement is formed on the outer circumference of said driving wheel, said rim is constructed by a plurality of ring-shaped spacer plates of a same shape in each of which a concave portion and a convex portion are alternately formed on the outer circumference so that said concave surface portions and said convex portions are formed when said spacer plates are piled, and an interval between said elastic pads with which said disks are come into engagement can be adjusted by increasing or decreasing the number of said spacer plates which are fitted into said boss in accordance with a radius size of the disk of said disk cable which is used.
